(19) United States
(12) Patent Application Publication
(10) Pub. No.: US 2024/0422063 A1
(43) Pub. Date: Dec. 19, 2024

(54) A Method for Network Configuration in Dense Networks

(71) Applicant: Telefonaktiebolaget LM Ericsson (publ), Stockholm (SE)

(72) Inventors: Prayag Gowgi Somanahalli Krishna Murthy, Mandya (IN); Vijaya Parampalli Yajnanarayana, Bangalore (IN); Anusha Pradeep Mujumdar, Bangalore (IN)

(21) Appl. No.: 18/702,996

(22) PCT Filed: Oct. 20, 2021
(86) PCT No.: PCT/IN2021/050995

§ 371 Date: Apr. 19, 2024

(51) Int. Cl. H04L 41/0893; H04W 16/18

(52) U.S. Cl. CPC H04L 41/0893; H04W 16/18

(57) ABSTRACT

The disclosure relates to a computer-implemented method for configuring at least one operation parameter in a network cell (140) served by a network node (110) of a communication network (100), the method comprising: (S210) obtaining at least one cell feature for each one of a plurality of network cells (140), the cell feature representing a cell state of respective network cell (140), (S220) clustering a number of network cells (140) into a number of cell clusters (160), wherein the clustering of network cells (140) is performed based on the obtained at least one cell feature of respective network cell (140), (S230) determining one network cell (140) of respective cell cluster (160) to be a representor cell (170), and for at least one cell cluster (160): (S240) determining at least one action (a) to be performed for configuring at least one operation parameter for a number of network cells (140) of respective cell cluster (160).

### TECHNICAL FIELD

The disclosure generally relates to methods for network configuration in dense network environments. More particularly, the disclosure relates to methods using correlation between network cells to enable improved data management and network operation. The disclosure relates to methods, apparatuses and systems configured to perform such methods.

### BACKGROUND

Currently the Fifth Generation, 5G, of cellular, wireless communication systems, herein primarily referred to as New Radio, NR, is being standardized within the Third Generation Partnership Project, 3GPP. NR is developed for maximum flexibility to support multiple and substantially different use cases. These use cases include for example enhanced Mobile Broadband, eMBB, Machine Type Communications, MTC, Ultra-Reliable Low Latency Communications, URLLC, side-link Device-to-Device communication, D2D communication, just to mention a few. NR was initially specified in 3GPP Release 15, Rel-15, and has continued to evolve, and still continues to evolve, throughout subsequent releases, such as Rel-16, Rel-17 and yet later releases to come.

NR communication networks are expected to meet ever-increasing numbers of Key Performance Indicators, KPIs, including latency, reliability and user experience, just to mention a few, but also increases the complexity or the system. The increased degree of configurability entails optimization challenges, introduced by features such as for example multi-Radio Access Technology, Multi RAT, Dual Connectivity, MR-DC, beamforming, and network slicing.

NR technology shares many similarities with the Fourth Generation, 4G, of cellular, wireless communication system, Long-Term Evolution, LTE. A wireless communication system such as NR or LTE generally covers a geographical area which is divided into geographical areas generally referred to as network cells, cell areas or simply cells. Each network cell area is served by at least one base station. LTE base stations are generally referred to as evolved NodeBs, eNodeBs or eNBs, whereas NR base stations are generally referred to as next generation NodeBs, gNodeBs or gNBs. Wireless communication systems are generally also referred to as for example communications networks, mobile communication systems and wireless networks. Base stations are generally also referred to as for example access points, network nodes or RAN nodes, and are further discussed below.

In comparison to LTE, NR is generally deployed in a more dense manner, generally leading to for example more frequent handovers. Another difference is that for NR time-frequency resources can be configured in a more flexible manner. For example, rather than a fixed 15-KHz OFDM Sub-Carrier Spacing, SCS, as in LTE, NR SCS can range from 15 to 240 kHz, with even greater SCS considered for future NR releases.

In addition to providing coverage via network cells as in LTE, NR communication networks also provide coverage via beams, by applying beamforming, and offers operation over mid and high band, also referred to a millimeter Wave, mmWave. The dense deployment and operation over mmWave bands are some of the key approaches to boost network capacity. Dense deployment of mmWave small cells using narrow directional beams will escalate the network cell and beam related handovers, for example for high mobility vehicles taking advantage of NR capabilities.

In order to take full advantage of the possibilities offered by NR, and to maximize the capacity of NR communication networks, NR communication networks demand rigorous control. Traditional human-machine interaction may be too slow, may provide an unacceptable error rate, and/or may be too expensive for managing the opportunities and challenges with NR and later generations of communication networks.

Various forms of Artificial intelligence, AI, provides a powerful tool to help operators reduce the network complexity and improve the user experience by analyzing the large amount of data collected, and autonomously looking for patterns that can yield further insights and be used for network operation optimization.

In general, AI refers to any human-like intelligence exhibited by a computer or other machine. Machine Learning, ML, is a type of AI that learns by itself to perform a specific assigned task with increasingly greater speed, accuracy, etc., such as by reprogramming itself as it digests more data and/or feedback. ML typically involves various phases: a training phase, in which algorithms build a computational operation based on some sample input data; and an inference phase, in which the computational operation is used to make predictions or take decisions.

ML is generally divided into supervised learning, semi-supervised learning, unsupervised learning and Reinforcement Learning, RL. On a high level, in RL Reinforcement Learning agents, RL agents, learn a management policy from past experiences with the aim of optimizing a long-term reward. This can also be explained as that the aim of the RL agent is to maximize a selected Key Performance Indicators, KPI. An RL problem may for example be modeled as a Markov Decision Process, MDP, describing the environment of an RL agent, and may include components such as a state space, (S), an action space, (A), a transition function (T), a reward function (R), used to predict a reward, r, and a management policy, IT. On a high level, during the training, or learning, of an RL agent the agent; starts from a state of the state space, from that state explores possible actions of the actions space; observes consequences of the explored actions; calculates a reward of respective action; and finally updates its management policy with the aim of maximizing short- and/or long-term future reward. There are various RL methods, whereof policy based, model based, model-free, value based and Actor-Critic based are some of the most commonly used.

Applying traditional RL solutions to a large scale cellular system pose several challenges. These challenges include for example scalability and significant need of computational resources, in turn leading to high energy consumption. Significant need of computational resources and energy consumption are two of the most important challenges since the demand for computational resources and energy increase exponentially with the advent of data driven telecommunication systems. Thus, there is room for further improvements.

### SUMMARY

As mentioned, future communication networks are highly dynamic, whereby network control, network para meter tuning etc. is important in order to fully take advantage of the possibilities offered. Applying RL is one potential solution for optimizing network performance. Use of RL may enable large scale, highly dynamic network systems to learn from experience. However, as previously mentioned, applying traditional RL solutions to a large scale, multi-cellular systems pose several challenges. One particular challenge when applying RL methods to the large-scale networks is what generally is referred to as state space explosion. State space explosion leads to high computational needs, in turn leading to large energy consumption, and may also lead to unacceptable latency.

It is an objective of the present disclosure to provide methods for network configuration in dense networks which addresses some of these issues, and apparatuses configured for performing such methods. The present disclosure proposes embodiments, aspects or examples of methods with the overall objective of determining configuration and parameter tuning of communication networks by grouping similar network cells together, particularly to exemplary embodiments aiming at reducing the state action space by grouping network cells with similar characteristics together. Determined actions may subsequently be shared among grouped network cells. The present disclosure provides the advantage that the need for computational resources will be reduced, energy consumption may be lowered, and the overall network performance may be improved.

According to one example of the present disclosure, this objective is obtained by a computer-implemented method for configuring at least one operation parameter in a network cell served by a network node. Configuring one, or a number of, operation parameters in a network cell enables improved network configuration of dense communication networks. Various operation parameters that the present disclosure may be applied to configure are for example: mobility parameters, power control parameters, radio cells configuration and/or Random Access Channel, RACH, configuration parameters. Further examples of operation parameters are discussed below. The various steps of methods of the disclosure are performed in, or by, a control node and/or by network nodes of a communication network, the communication network comprising a Radio Access Network, RAN, connecting a plurality of network nodes, each network node serving at least one network cell. The communication network may be a current, or future, wireless communication system operating for example according to a standard defined by 3GPP. Examples of methods of the disclosure comprise the method steps of:
obtaining, or extracting, at least one cell feature from each one of a plurality of network cells, the cell feature representing a cell state of respective network cell, and wherein the cell features may be put together as a vector characterizing the network cell,
clustering a number of network cells, for which at least one cell feature has been obtained, into a number of cell clusters, wherein the clustering of network cells is performed based on the obtained at least one cell feature of respective network cell,
determining one network cell of respective cell cluster to be a representor cell of respective cell cluster,
   and for at least one cell cluster:
determining at least one action (a) to be performed for configuring at least one operation parameter for a number of network cells of respective cell cluster, based on the at least one cell feature of the representor cell, of the concerned cell cluster.

As will be discussed more in detail herein, the first three method steps; obtaining, clustering and determining representor cell, are generally, but not limited to, performed in, or by, a control node whereas the last step; determining at least one action, is performed either in, or by, a control node, or in, or by, a network node. It is also appreciated that the control node may be implemented at a network node.

According to one embodiment of the present disclosure, the method further comprises the method step of:
providing information to the network nodes serving the network cells from which at least one cell feature has been obtained and for which at least one action (a) to be performed has been determined, enabling respective network node to perform said at least one action (a). An advantage of the proposed solution is that by selecting a set of representor cells to represent all the network cells, as a result of clustering a number of, preferably all, network cells, the at least one action, or a plurality of actions to be performed in sequence and/or simultaneously, determined for the representor cell can be percolated to a number of, preferably all, network cells of the cell cluster. The actions are performed by a network node of respective network cell.

According to examples of the present disclosure, the method step of determining at least one action (a) to be performed for configuring at least one operation parameter for a number of network cells of respective cell cluster is performed using a Reinforcement Learning, RL, agent.

A particular advantage of embodiments of the disclosure where an RL agent is applied to determine at least one action to be performed is that by determining a set of representor cells to represent all the network cells, as a result of clustering of the network cells, the state space of the RL agent acting within the large, cellular communication system will be significantly reduced.

The RL agent interacts with the environment and determines an action, or a sequence of actions, for the representor cell of a cell cluster, to optimize a certain objective function, and in line with what previously has been discussed, the same action, or sequence of actions, may then be percolated to the rest of the network cells of the cell cluster. Once again, applying embodiments of the method of the present disclosure results in less need of computational resources, lower energy consumption and improved performance.

Depending on if the step of determining actions to be performed is performed at the control node or at a network node the RL agent is either implemented at the control node or at a network node. It is appreciated that depending on where the RL agent is implemented, some additional signaling of information between involved nodes may be required, as discussed more in detail herein. The RL agent may either be what herein is referred to as Master RL agent, determining actions for multiple cells clusters, or a Local RL agent, configured to only determine actions for the network cells of one single cell cluster. An advantage of implementing a Master RL agent is that a Master RL agent may consider the state, represented by cell features, of each cell cluster as an attribute in a state vector when determining actions.

Note that according to examples of the disclosure, the sequence of actions may be one action or multiple actions performed in sequence and/or simultaneously.

For further clarification, according to examples of the present disclosure, the Reinforcement Learning, RL, agent determines the action (a) to be performed based on a Reinforcement Learning, RL, agent policy π, wherein the Reinforcement Learning, RL, agent policy π provides a strategy for suggesting suitable actions (aₙ) given a current state (s) of the environment the Reinforcement Learning, RL, agent is acting in.

According to one embodiment of the present disclosure, for every action (a) performed by a network node, for a network cell, a reward (r), indicating, or representing, an observed impact of performing the action (a) given the current state (s) of the network cell, is calculated based on a performance metric of the network cell, network node and/or at least a part of the communication network.

Thus, when performing the method at time t;

Given a state (sₜ) of the representor cell the k^{th} cell cluster, the method of the present disclosure is applied to determine at least one action (aₜ) to be performed in the representor cell and all other network cells of the k^{th} cell cluster. Thus, the action (aₜ) will generally (exceptions are discussed herein) be the same for all network cells nₖ, of the k^{th} cell cluster. A reward (rₜ) is calculated for respective network cell and is provided to the representor cell. The representor cell aggregates the provided rewards (r_{n,t}) to a cumulative reward (r_{tot,t}) of the k^{th} cell cluster. The cumulative reward (r_{tot,t}) may subsequently be evaluated to determine if the action (aₜ) performed at time t was favorable or not. By performing the action (aₜ) the network cells transition to a new state (sₜ₊₁). The cumulative reward (r_{tot,t}) is used by the RL agent when selecting a new action (aₜ₊₁). As will be discussed more in detail herein, an RL agent may also look at individual rewards (rᵢ) for network cells. Calculating reward (r) is also discussed in detail herein. This enables the RL agent to learn from experience and to continuously update the agent policy.

According to other examples of the disclosure, the method further comprises detecting conflicting outcomes of performing said at least one action (a) in network cells nₖ of a cell cluster by evaluating the rewards (rₙ) calculated for respective network cell.

According to examples of the disclosure, detecting conflicting outcomes may be performed by performing the method step of, for all network cells nₖ of a cell cluster, a positive reward (r) is assigned a value of y=1 and a negative reward (r) is assigned a value of y=0, and wherein all assigned values are summed up as yₖ, and wherein if yₖ<nₖ a conflicting outcome in a cell cluster is detected.

As is further discussed herein, an obvious advantage of this embodiment is that network cells not benefitting from performing an action (a) can be detected. Detected inter-cell conflicts may be considered during later iterations of the method.

According to yet other examples of the present disclosure, if the total number of conflicting outcomes detected in a plurality of cell clusters exceeds a threshold value v, re-clustering is triggered.

As also is further discussed herein, an obvious advantage with this embodiment is that intra-cell conflicts can be detected. Detected intra-cell conflicts may be also considered during later iterations of the method.

According to examples of the disclosure, the Reinforcement Learning, RL, agent is a Local Reinforcement Learning, RL, agent, wherein each cell cluster is provided with one Local RL agent each, or the Reinforcement Learning, RL, agent may be a Master Reinforcement Learning, RL, agent configured to determine at least one action (a) to be performed for configuring at least one operation parameter for a number cell cluster.

Advantages of Local versus Master RL agents is further discussed herein.

As mentioned, methods of the disclosure are generally performed by a control node and a network node. According to examples of the disclosure the control node performs the method steps of:
obtaining at least one cell feature for each one of a plurality of network cells, the cell feature representing a cell state of respective network cell,
clustering a number of network cells into a number of cell clusters, wherein the clustering of network cells is performed based on the obtained at least one cell feature of respective network cell, and
determining one network cell of respective cell cluster to be a representor cell.

According to examples of the disclosure, the control node may also perform the method step of, for at least one cell cluster, determining at least one action (a) to be performed for configuring at least one operation parameter for a number of network cells of respective cell cluster, based on the at least one cell feature of the representor cell. This is for example true for embodiments implementing a Master RL agent.

According to other examples of the disclosure the network node performs the method steps of:
providing at least one cell feature for a network cell served by the network node, the cell feature representing a cell state of the network cell,
obtaining information enabling at least one action (a) to be performed, and
causing the at least one action (a) to be performed.

According to examples of the disclosure, a network node may also perform the method step of, for at least one cell cluster, determining at least one action (a) to be performed for configuring at least one operation parameter for a number of network cells of respective cell cluster, based on the at least one cell feature of the representor cell. This is for example true for embodiments implementing a Local RL agent.

Methods performed by control nodes and/or network nodes contribute to achieving the objectives of the disclosure, and contribute to achieving the advantages previously mentioned.

Other embodiments, features, objectives and advantages of methods performed in a control node and/or a network node of a communication network, according to the present disclosure, will be apparent from the following detailed description, from the claims as well as from the drawings.

There are also disclosed herein examples of control nodes, network nodes and systems configured for performing embodiments of the methods disclosed, as well as examples of computer programs, computer program products and computer readable mediums related to the disclosure.

Generally, all terms and terminology used in the specification are to be interpreted according to their ordinary meaning in the technical field, unless explicitly defined otherwise herein. All references to “a”, “an” and “the” element, apparatus, component, means, module, action, etc.” are to be interpreted openly as referring to at least one instance of the element, apparatus, component, means, module, action, etc., unless explicitly stated or the context clearly indicates otherwise. The actions of any method disclosed herein do not necessarily have to be performed in the exact order disclosed, unless explicitly stated or obvious from a logical point of view.

### BRIEF DESCRIPTION OF THE FIGURES

The disclosure will now be described in more detail with reference to the appended figures, where:

FIG. 1 schematically illustrates an exemplary 5G/NR architecture,

FIG. 2a schematically illustrates an example of a multicellular communication system,

FIG. 2b schematically illustrates an example of the disclosure,

FIG. 2c schematically illustrates the high-level method steps required for achieving objectives of examples of the disclosure,

FIG. 3 shows a flow chart schematically illustrating a first example of the present disclosure,

FIG. 4 shows a flow chart schematically illustrating a second example of the present disclosure,

FIG. 5 shows a flow chart schematically illustrating a third example of the present disclosure,

FIG. 6 schematically illustrates an example of the disclosure of how conflicting outcome may be detected,

FIGS. 7a and 7b schematically illustrate exemplary implementations of the present disclosure,

FIG. 8 schematically illustrates another exemplary implementation of the present disclosure,

FIG. 9 schematically illustrates a data-driven approach for handling intra-cell cluster conflict detection,

FIG. 10 schematically illustrates an example of the disclosure of inter-cell cluster conflict handling,

FIGS. 11a and 11b show flow charts schematically illustrating an example of the present disclosure, from the perspective of a network node,

FIG. 12 schematically illustrates the general components of a network node and/or a control node, and

FIG. 13 schematically illustrates an example of the disclosure of a virtual realization of a control node.

### DETAILED DESCRIPTION

Exemplary embodiments, examples and aspects of the present disclosure will now be described more fully with reference to the accompanying figures. The different devices, systems, computer programs and methods disclosed herein can, however, be realized in many different forms and should not be construed as being limited to the exemplary embodiments and examples set forth herein. When same reference numerals are used in more than one figure, generally they indicate the same element. Numbered elements indexed with a letter or number refers to different individuals of the same type of element. As will be apparent for the skilled person, when herein using the index n, this is considered to represent that there may be more than one of the referred to element, but n should not be construed as always representing the same number of element. When using the indexes k and i, this is used to indicate any arbitrary individual element out of a plurality of elements. In general, dashed lines or boxes indicate optional steps and/or operations.

Throughout the description the following terms are generally used: Network Node: As used herein, a “network node” (or equivalently “radio access node”, “radio network node,” “radio access network node,” or “RAN node”) can be any node in a Radio Access Network, RAN, of a currently existing or future cellular communications network that operates to wirelessly transmit and/or receive signals. For the purposes of the present specification, a network node of a communication network comprises a node that is operable to transmit, receive, process and/or orchestrate wireless signals. A network node may comprise a physical node and/or a virtualized network function. Some examples of a radio access node include, but are not limited to, a base station (for example a New Radio, NR, base station, gNB, in a 3GPP Fifth Generation, 5G, NR network), base station distributed components (for example CU and DU), a high-power or macro base station, a low-power base station (for example micro, pico, femto, or home base station, or the like), an Integrated Access Backhaul, IAB, node, a transmission point, a Remote Radio Unit, RRU or RRH, a relay node, a communications satellite, and an earth gateway for satellites. Core Network Node: As used herein, a “core network node” may for example be any type of node in a NR core network. Some examples of a core network node include, for example an Access and Mobility management Function, AMF, a Session Management Function, SMF, a User Plane Function, UPF, a Network Exposure Function, NEF, or the like. Wireless Device: As used herein, a “wireless device” is any type of device that has access to, thus is served by, a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, Personal Digital Assistants, PDAs, wireless cameras, gaming consoles or devices, music storage devices, playback appliances, wearable devices, wireless endpoints, mobile stations, tablets, laptops, Laptop-Embedded Equipment, LEE, Laptop-Mounted Equipment, LME, smart devices, wireless Customer-Premise Equipment, CPE, Mobile-Type Communication, MTC, devices, Internet-of-Things, IoT, devices, vehicle-mounted wireless terminal devices, D2D UEs, V2X UEs, and similar. Unless otherwise noted, the term “wireless device” is used interchangeably herein with the term User Equipment, UE.

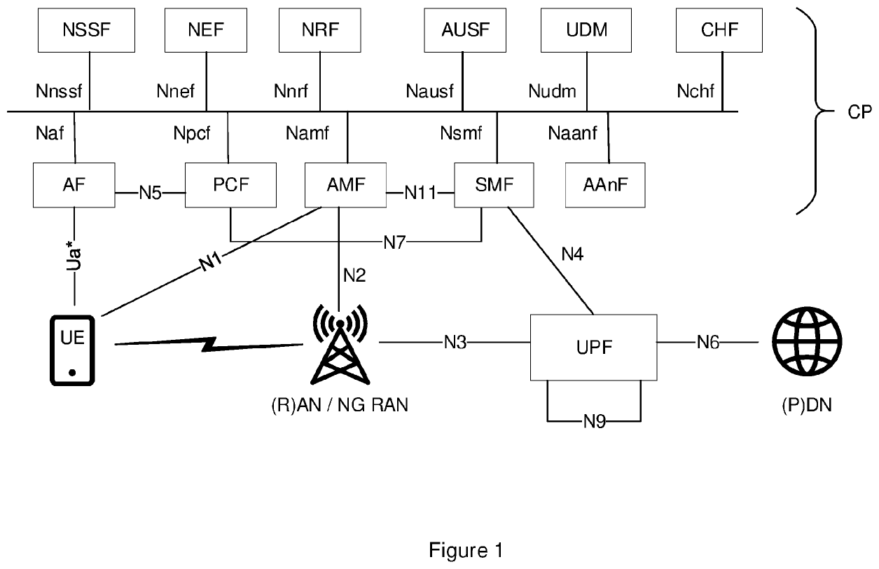

FIG. 1 schematically illustrates an exemplary NR architecture with service-based interfaces and various 3GPP-defined Network Functions, NFs, within the Control Plane, CP, and their interfaces. The NR architecture, the NFs and the interfaces are defined in 3GPP specifications. The present disclosure may be, but is not limited to be, applied in an LTE, NR, or future, architecture communication network. Although throughout the specification the present disclosure generally is presented, discussed and referred to in an NR context, it is appreciated that it is apparent for a person skilled in the art that the present disclosure is not limited to being implemented in NR communication systems and for NR communication networks, but that the disclosure may equally well be applied for a wireless communication systems beyond NR, such as for example a 6^{th} generation of wireless communication systems, 6G.

Some details of the NR architecture communication network are provided:

Application Function, AF, with Naf interface, interacts with the 5G Core, 5GC, to provision information to the network operator and to subscribe to certain events happening in operator's network. An AF offers applications for which service is delivered in a different layer (thus transport layer) than the one in which the service has been requested (thus signaling layer), the control of flow resources according to what has been negotiated with the network. An AF communicates dynamic session information to PCF (via N5 interface), including description of media to be delivered by transport layer. Policy Control Function, PCF, with Npcf interface, supports unified policy framework to govern the network behavior, via providing PCC rules (for example on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events. User Plane Function, UPF, supports handling of user plane traffic based on the rules received from SMF, including packet inspection and different enforcement actions (for example event detection and reporting). UPFs communicate with the RAN (for example NG-RNA) via the N3 reference point, with SMFs (discussed below) via the N4 reference point, and with an external Packet Data Network, (P) DN, via the N6 reference point. The N9 reference point is for communication between two UPFs.

Session Management Function, SMF, with Nsmf interface, interacts with the decoupled traffic (or user) plane, including creating, updating, and removing Protocol Data Unit, PDU, sessions and managing session context with the User Plane Function, UPF, for example for event reporting. For example, SMF performs data flow detection (based on filter definitions included in PCC rules), online and offline charging interactions, and policy enforcement.

Charging Function, CHF, with Nchf interface, is responsible for converged online charging and offline charging functionalities. It provides quota management (for online charging), re-authorization triggers, rating conditions, etc. and is notified about usage reports from the SMF. Quota management involves granting a specific number of units (for example bytes, seconds) for a service. CHF also interacts with billing systems.

Access and Mobility Management Function, AMF, with Namf interface, terminates the RAN CP interface and handles all mobility and connection management of UEs. AMFs communicate with wireless devices, or UEs, via the N1 reference point and with the RAN (for example NG-RAN) via the N2 reference point.

Network Exposure Function, NEF, with Nnef interface, acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (for example expected UE behavior) for various UEs.

Network Repository Function, NRFm with Nnrf interface, provides service registration and discovery, enabling NFs to identify appropriate services available from other NFs.

Network Slice Selection Function, NSSF, with Nnssf interface, a “network slice” is a logical partition of a 5G communication network that provides specific network capabilities and characteristics, for example in support of a particular service. A network slice instance is a set of NF instances and the required network resources (for example compute, storage, communication) that provide the capabilities and characteristics of the network slice. The NSSF enables other NFs (for example AMF) to identify a network slice instance that is appropriate for a UE's desired service.

Authentication Server Function, AUSF, with Nausf interface, based in a user's home network, HPLMN, it performs user authentication and computes security key materials for various purposes.

Location Management Function, LMF, with NImf interface, supports various functions related to determination of for example UE locations (herein generally referred to as wireless device), including location determination for a UE and obtaining any of the following: DL location measurements or a location estimate from the UE; UL location measurements from the NG RAN; and non-UE associated assistance data from the NG RAN.

The Unified Data Management, UDM, function supports generation of 3GPP authentication credentials, user identification handling, access authorization based on subscription data, and other subscriber-related functions. To provide this functionality, the UDM uses subscription data (including authentication data) stored in the 5GC Unified Data Repository, UDR. In addition to the UDM, the UDR supports storage and retrieval of policy data by the PCF, as well as storage and retrieval of application data by NEF.

Communication links between the UE and a 5G network (AN and CN) can be grouped in two different strata. The UE communicates with the CN over the Non-Access Stratum, NAS, and with the AN over the Access Stratum, AS. All the NAS communication takes place between the UE and the AMF via the NAS protocol (N1 interface). Security for the communications over this these strata is provided by the NAS protocol (for NAS) and a PDCP protocol (for AS).

PHY, MAC, RLC, and PDCP layers between the UE, thus wireless device, and the gNB, thus network node, are common to both the User Plane, UP, and the Control Plane, CP. PDCP provides ciphering/deciphering, integrity protection, sequence numbering, reordering, and duplicate detection for CP and UP. In addition, PDCP provides header compression and retransmission for UP data.

On the UP side, Internet protocol, IP, packets arrive to the PDCP layer as Service Data Units, SDUs, and PDCP creates Protocol Data Units, PDUs, to deliver to RLC. In addition, the Service Data Adaptation Protocol, SDAP, layer handles quality-of-service, QoS, including mapping between QoS flows and Data Radio Bearers, DRBs, and marking QoS flow identifiers, QFI, in UL and DL packets.

When each IP packet arrives, PDCP starts a discard timer. When this timer expires, PDCP discards the associated SDU and the corresponding PDU. If the PDU was delivered to RLC, PDCP also indicates the discard to RLC. The RLC layer transfers PDCP PDUs to the MAC through Logical Channels, LCH. RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from Transport Blocks, TBs, Hybrid ARQ, HARQ, error correction, and dynamic scheduling (on gNB side). The PHY layer provides transport channel services to the MAC layer and handles transfer over the NR radio interface, for example via modulation, coding, antenna mapping, and beam forming.

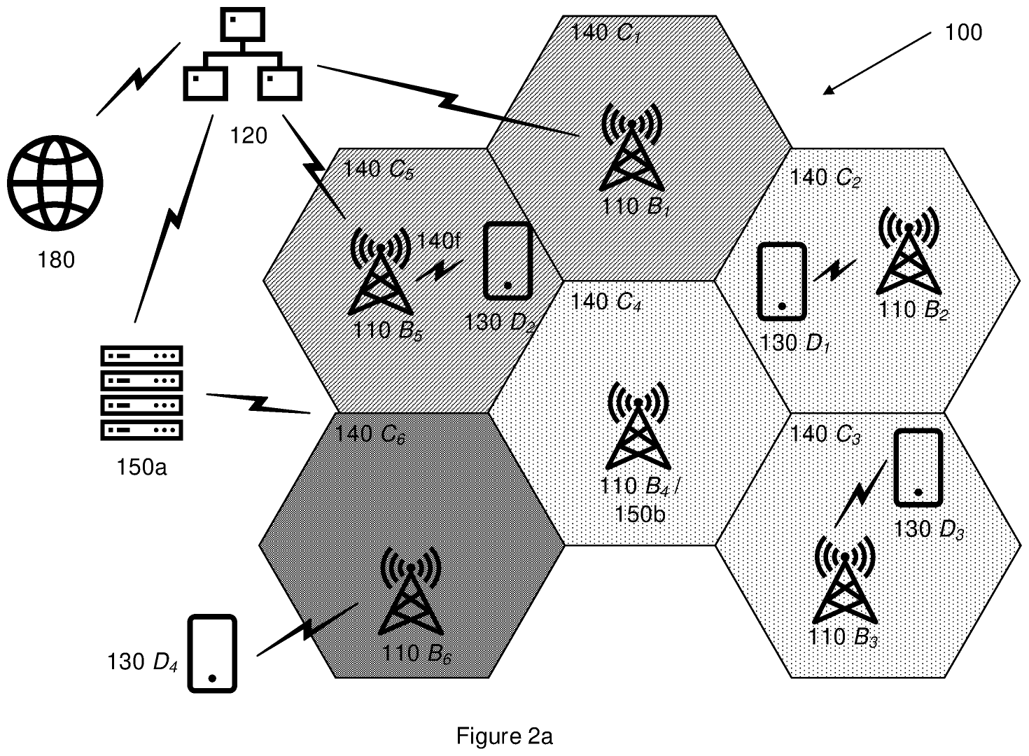

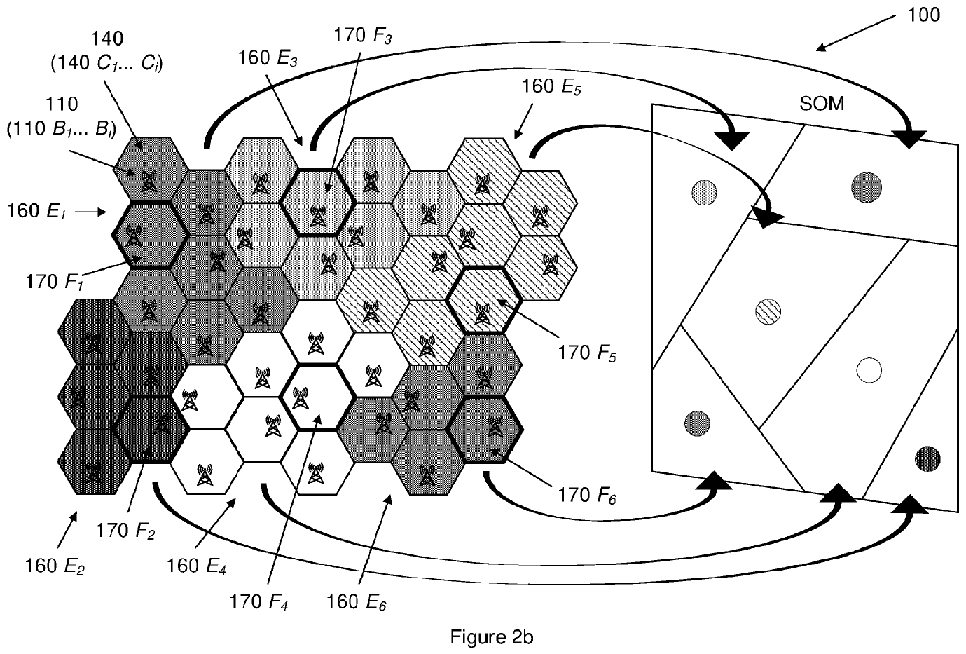

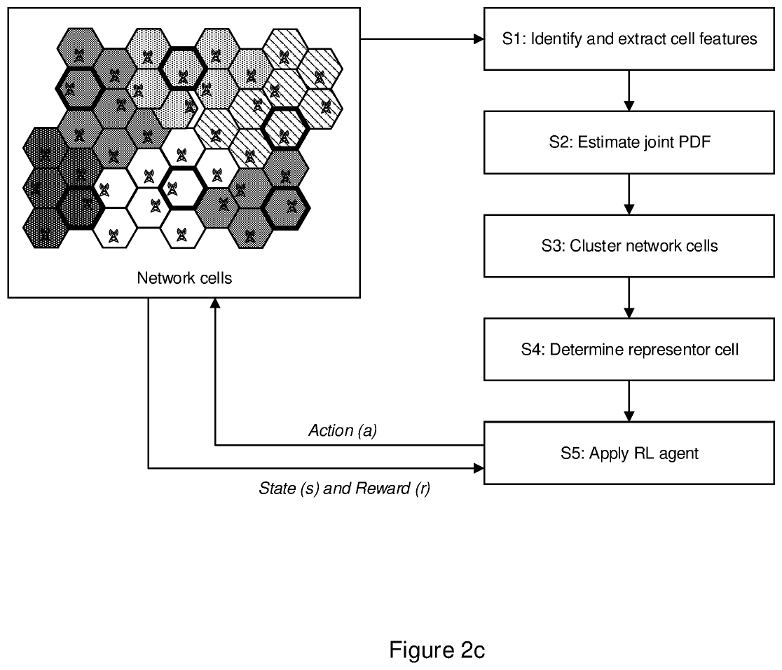

FIG. 2a schematically illustrates an example of the disclosure of a multicellular communication network 100, also referred to as communication system, according to the present disclosure. Communication network and communication system is herein used interchangeably. The communication network 100 comprises, or consists of, a Radio Access Network, RAN, in turn comprising a number of connectable access points or Radio Access Network nodes, RAN nodes, 110 (110 B₁, 110 B₂, 110 B₃, 110 B₄, 110 B₅, 110 B₆), providing radio coverage over the geographical area in which the communication network 100 is deployed. The RAN nodes, herein generally simply referred to as network nodes 110, provide wireless access to a number of wireless devices 130 (130 D₁, 130 D₂, 130 D₃, 130 D₄) in a number of network cells 140 (140 C₁, 140 C₂, 140 C₃, 140 C₄, 140 C₅, 140 C₆), each network cell 140 being served by at least one network node 110. The network nodes 110 are connectable to a core network 120, such as for example a 5GC, whereby the wireless devices 130 are connectable to the core network 120 via the radio access network nodes 110. The core network 120 may further be connected to a (Packet) Data Network 180, (P)DN, for example providing operator services, internet access or third party services.

As mentioned, the communication network 100 may be part of a Fifth Generation, 5G, communication system, herein generally referred to as New Radio, NR, communication system, as defined by the third generation partnership program, 3GPP.

FIG. 2a further shows a control node 150. According to examples of the present disclosure, the control node 150 may be implemented as a separate network functionality 150a, implemented in or as a remote server, connectable to the RAN network and/or core network 120, or be implemented in a network node 150b.

According to examples of the disclosure, the control node 150 may be implemented as a virtual machine in a cloud computing architecture, an edge cloud computing architecture, a fog deployment, as a function in Centralized-RAN, C-RAN and/or as a function in an Open RAN, O-RAN.

It should also be highlighted that the methods disclosed herein may advantageously be performed jointly in, or at, more than one entity such as for example in one, or more than one, implementations of a control node, and/or in one, or more than one, implementations of a network node, or any combination thereof.

Referring now to FIGS. 2b and 2c, schematically illustrating examples of the present disclosure. FIG. 2b illustrates how a geographical area is covered by a plurality of network cells 140 (140 C₁, . . . , Cₜ where i=1, . . . , n) of a multicellular communication network 100, and how applying a Self-Organizing Map, SOM, algorithm may be used when executing methods of examples of the present disclosure.

FIG. 2c schematically illustrates the high-level method steps of examples of the disclosure required for achieving objectives of the present disclosure.

The geographical area over which the communication network 100 provides radio coverage is divided into different network cells 140 (140 C₁, . . . , Cᵢ; where Cᵢ denotes network cell i=1, . . . , n), and each of the network cells 140 is served by a network node 110 (110 B₁ . . . . Bᵢ; where Bᵢ denotes network node i=1, . . . , n). The cell state, herein also referred to as state (s), of each network cell 140 is characterized by different features, herein generally referred to as cell features. Such cell features can be compiled to form a feature vector characterizing a network cell 140 at a time t, herein generally referred to as state vector. The complete description of a network cell 140 may be provided by the joint Probability Density Function, PDF, of the state vector. The joint PDF may for example be estimated by using a Kernel Density Estimation, KDE, Technique. The estimated joint PDF of the state of a network cell 140 describes the stochastic environment of the network cell 140, and two different network cells 140 may be very similar in terms of joint PDF. It should be noted that when herein referring to “at least one cell feature”, this is to be interpreted as that in extreme cases, examples of the present disclosure may be performed using just one cell feature, but generally a number of cell features, for example expressed as a vector of cell features, are used.

Herein after, when referring to cell features, that is considered to also comprise the extreme case where only one feature is considered.

According to examples of the disclosure, different network cells 140 with same, or at least similar, joint PDF may be grouped to belong to the same cell cluster 160 (160 E₁, 160 E₂, 160 E₃, 160 E₄, 160 E₅, 160 E₆). The clustering may be performed for example by applying the Self-Organizing Map, SOM, algorithm, as shown in FIG. 2b. SOM is an unsupervised Machine Learning, ML, algorithm which is neuro-biologically motivated and may be considered as a clustering algorithm that preserves topological properties of the input space. As shown in FIG. 2b, SOM further provides the advantage that it may be used to visualize high dimensional network cell data in a lower dimension. Thus, SOM may also be considered as a dimensionality reduction technique. This procedure is schematically illustrated in FIG. 2c. Applying SOM includes using any of the commonly known distance functions, for example Kullback-Leibler, KL, divergence distance or any suitable variation of Euclidian distance.

It is appreciated that other unsupervised clustering algorithms than SOM, such as for example k-Nearest Neighbor Classifier, k-NNC, technique, using for example any suitable variation of Euclidian distance metric, DBSCAN or HDBSCAN, may alternatively be used, and that the present disclosure is not limited to applying SOM as clustering technique.

As is discussed herein, for each cell cluster 160 a representor cell 170 (170 F₁, 170 F₂, 170 F₃, 170 F₄, 170 F₅, 170 F₆) is determined.

Referring now to FIG. 2c, disclosing the high-level method steps of examples of the disclosure.

In a first step S1, of the high-level method, relevant cell features characterizing respective network cell, of the plurality of network cells, is identified and extracted. Which cell features that are identified and extracted is for example determined by which configuration parameters the method is applied to configure, thus by the use case.

In a second step S2 the joint PDF is estimated, for example by using a KDE technique.

In a third step S3 the estimated joint PDF is used to group or cluster the network cells into different cell clusters, wherein each cell cluster will contain network cells that are similar in terms of the estimated joint PDF. As previously exemplified, the clustering may for example be performed using algorithms such as SOM, for example using on Kullback-Leibler, KL, divergence distance or variations of Euclidian distance.

Still referring to the examples of the disclosure of FIGS. 2b and 2c; the computational complexity in terms of for example running time and space requirements O of a SOM algorithm is:

$$O ( {N}_{d} E ) \qquad ( 1 )$$

where N_{d} is the dimension of the input space and E is number of epochs during training. Typically, the number of clusters M is chosen as:

$$M = \sqrt{N} \qquad ( 2 )$$

where N is the cardinality of the input space. For example, if there are N=1000 network cells, then we choose M=┌\sqrt{1}000┐=32 cell clusters. The number of cell clusters may however also be determined based on other criteria such as for example; available computational resources (the higher number of cell clusters, the more computational resources are required when executing the method), or latency requirements (the higher number of cell clusters, the longer time for a Reinforcement Learning, RL, agent to determine at least one action (a) to be performed for configuring at least one operation para meter for network cells of respective cell cluster).

In a fourth step S4, for each cell cluster a representor cell is determined. Because of the S3 clustering, followed by S4 determining the representor cell of respective cell cluster, the large number of network cells that otherwise would have to be considered is reduced significantly.

According to examples of the disclosure, the choice of representor cell in each cell cluster may be identified by identifying the closest data point (this data point corresponds to some network cell) to the cell cluster center. If there are multiple such data points (corresponding to multiple network cells) then a network cell can be selected at random out of those candidate network cells as representor cell.

According to further examples of the disclosure, not shown in FIG. 2c, the clustering of network cells may for example be event driven in the sense that the set of cell clusters can be updated based on changes in the deployment of network nodes, leading for example to changes in cell boundaries, or that conflicts are detected.

As will be discussed more in detail below, according to further examples of the disclosure, re-clustering may be performed for example periodically, for example once every week or once every ten days, or due to a certain events, such as for example deteriorated network performance.

In a fifth step S5, for every cell cluster a Reinforcement Learning, RL, agent is applied to suggest a set of actions (at least one action), that may be sequential, to be performed by all, or at least a number of, network nodes serving network cells in respective cell cluster. The Reinforcement Learning, RL, agent may either be a Master RL agent, for example implemented in a control node, for example implemented in a remote server or in a cloud architecture, or the RL agent of a cell cluster may be a Local RL agent, preferably implemented in the representor cell of respective cell cluster. When herein referring to “at least one action”, this is considered to comprise extreme cases where the action performed is that no action should be performed and when only one action is determined to be performed. However, in most cases the “at least one action” corresponds to a sequence of actions, performed in parallel and/or in sequence. Hereinafter “at least one action” will generally be referred to as “an action” or simply “actions”.

As will be discussed more in detail below, when executed, the RL agent will use cell features, representing the state (s) of the representor cell as input and based thereon suggest at least one action (a) to be performed. Thus, applying examples of the present disclosure will drastically reduce the energy consumption and computational resource required since instead of having to determine actions (aₙ) to be performed by each network node one by one, which for example may require cell features to be measured and reported for each network cell, the same actions (aₙ) are determined and performed by a number of the network nodes of respective cell cluster. This will reduce energy consumption and computational resource required both since less input is required, resulting in for example that less measurements are required to be performed and reported, and since less RL agents are needed, performing fewer complex calculations.

To give an example; clustering carried out with M=32 cell clusters for the N=1000 network cells scenario, the state vector measurements will be of length 32 as opposed to a state vector of length 1000 with no clustering, resulting in 97% reduction in measurements that have to be performed and reported.

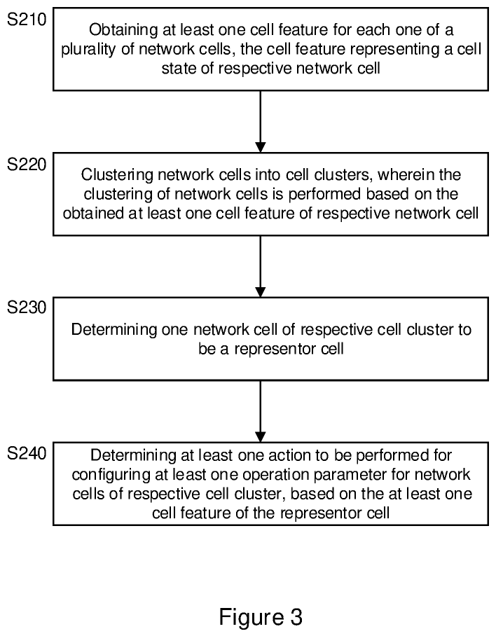

More detailed descriptions of various implementations and realizations of various examples of the present disclosure are hereafter provided in relation to the flow charts of FIGS. 3 to 5. 11a and 11b. As previously mentioned, the method of the present disclosure may be performed at a control node, a network node or the method may be performed jointly at different nodes, meaning that some method steps may be performed at the control node and some at a network node. FIG. 3 schematically illustrates a first example of the present disclosure. According to the example of the disclosure, the method steps S210, S220, S230, S240 of FIG. 3 are all performed by a control node. According to another example of the disclosure, method steps S210, S220, S230 are performed by a control node and method step S240 by a network node.

The example of the present disclosure of FIG. 3 refers to a computer-implemented method for configuring at least one operation parameter in a network cell served by a network node of a communication network, the method comprising:
S210 obtaining at least one cell feature for each one of a plurality of network cells, the cell feature representing, or being applicable to represent, a cell state of respective network cell,
S220 clustering a number of network cells into a number of cell clusters, wherein the clustering of network cells is performed based on the obtained at least one cell feature of respective network cell, and
S230 determining one network cell of respective cell cluster to be a representor cell of respective cell cluster,
and for at least one cell cluster:
S240 determining at least one action (a) to be performed for configuring at least one operation parameter for a number of network cells of respective cell cluster, based on the at least one cell feature of the representor cell, of the concerned cell cluster. Thus, the cell clusters comprise the network cells for which cell features have been obtained.

According to a first example of the present disclosure, method steps S210, S220, S230 and S240 are performed at a control node of the communication network.

According to a second embodiment of the present disclosure the method steps S210, S220 and S230 are performed at a control node of the communication network and the method step of S240 is performed a network node, preferably the network node of the representor cell of the cell cluster.

For the first and second examples of the disclosure, the method step of S210 obtaining at least one cell feature for each one of a plurality of network cells, the cell feature representing a cell state of respective network cell, may comprise respective network node transmitting the at least one cell feature for respective network cell and the control node receiving the at least one cell feature.

For the second example of the disclosure, the concerned network cells of a cell cluster need to be informed of which network cell that has been determined to be representor cell. This information may for example be provided to respective network node in a message, provided, thus transmitted, by the control node, to respective network node.

The state, state (s), of a network cell, herein generally referred to as the cell state of a network cell, is characterized by different cell features. Cell features defines the current state (s), at a given time t, and constitute the context from which actions (aₙ) are determined and executed. The cell features may be put together as a state vector characterizing the network cell at time t, v(state (s)). Which environmental conditions, current performance values, current parameter settings and/or other characteristics that are identified as features to be included and used as cell features depends first and foremost of the use case, or what operation parameters of the network cell the method disclosed herein is implemented to configure, thus what actions (aₙ) the RL agent is provided to suggest or take decision regarding. The cell state of a network cell may for example be characterized by one of, or a combined group of, measurable parameters, controllable parameters and/or parameter defining or indicating an attribute of the network cell. According to examples of the disclosure, the cell features may for example comprise measurements, characterizing the cell state, made by a wireless device or a radio access network node, such as for example neighboring network cell signal levels or signal quality, serving network cell signal level or signal quality, interference by neighboring network cells, and/or traffic characteristics. According to other examples of the disclosure, the cell features may for example also comprise KPIs such as (uplink and/or downlink) network cell throughput and/or (uplink and/or downlink) Signal-to-Interference-and-Noise Ratio, SINR, between a network node and a wireless device, thus may correspond to KPIs the actions (aₙ) suggested by the RL agent are expected to maximize. According to yet other examples of the disclosure, the cell feature may comprise network cell handover statistics, type of wireless devices served by one, or a plurality of, radio access network nodes of network cells and/or distribution of wireless devices in various network cells. In yet other examples of the disclosure, the cell features may comprise power attributes of a network node, the precoders employed, and/or power control parameters such as P0, Power HeadRoom, PHR, etc. used for individual network nodes.

It should be noted that preferably the action (a), or actions (aₙ), determined is performed in all network cells of respective cell cluster, but obviously the method of the present disclosure may be combined with additional functionality, for example various safety functionalities. Such functionality may for example be functionality that in some way over-rules or prevents specific actions to be performed for a specific network cell, given certain circumstances. When herein referring to that actions (aₙ) are performed in all network cells, this is considered to also include exceptional situations where at least one action (a) is, of some reason, not performed in at least one network cell.

Thus, according to one embodiment of the present disclosure an action (a), or plurality of actions (aₙ), is/are performed for all network cells of respective cell cluster.

Basically, all observable features can be used as cell features, but preferably the same cell features are used each time the method is executed. As mentioned, cell features relevant are for example determined by the operating parameters the method is applied to configure. Just to mention a few additional, explicit examples of what the cell features may comprise; for example at least one of; Channel State Information Reference Signal, CSI-RS, a Primary/Secondary Synchronization Signal, P/S-SS, Cell-specific Reference Signal, CRS, uplink and/or downlink Signal to Interference Noise Ratio, SINR, Sounding Reference Signal, SRS.

According to one example of the present disclosure, the at least one cell feature, preferably multiple cell features, to be provided to the control node is predefined, for example by being derivable from a lookup table stating potentially relevant cell features when applying examples of the disclosure for configuring various operation parameters. According to other examples of the disclosure, the cell features are determined and evaluated beforehand, for example iteratively evaluating various combinations of cell features or by using trial and error when training the RL agent.

To sum up, according to examples of the present disclosure, the cell feature comprises at least one feature, preferably multiple cell features, from a non-exhaustive list comprising: number of measurements performed and/or reported by at least one wireless device operating over, or being provided service by, the network node, network cell signal level of at least one neighboring network cell, measured and reported by a network node serving the at least one neighboring cell, network cell signal level of a network cell of the network node, interference caused by at least one neighboring network cell, measured by the network node, number of handovers to/from the network cell, and/or number of ping-pong handovers (back-and-forth handovers), information regarding mobility of wireless devices, and/or information regarding available Radio Access Technologies, RATs, within the network cell.

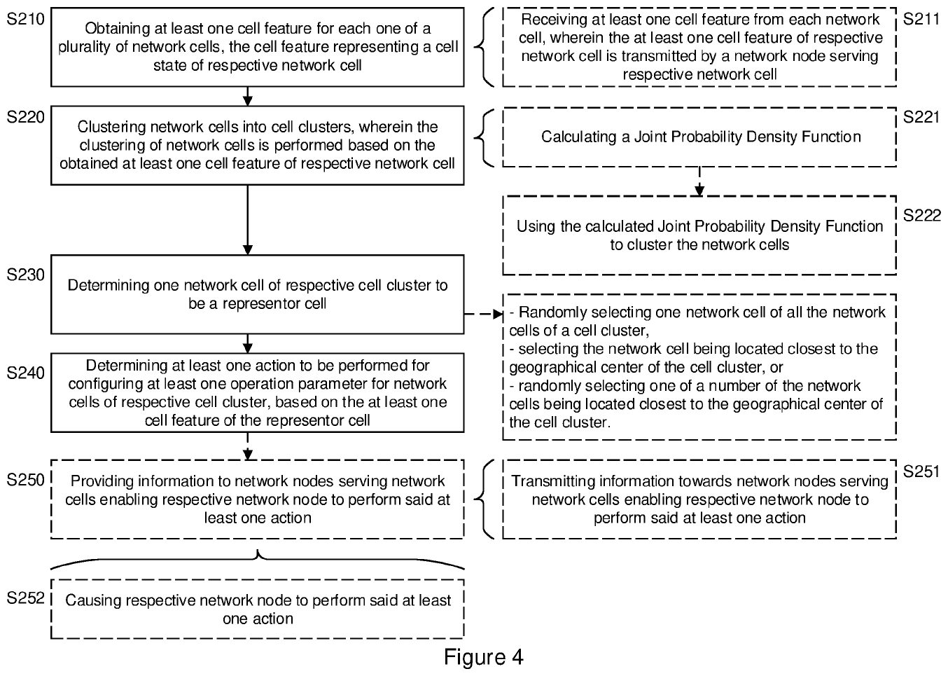

FIG. 4 schematically illustrates a flow chart over one example of the present disclosure, wherein method steps S210, S220, S230 and S240 are all performed at a control node of the communication network.

According to this embodiment the method step of S210: obtaining at least one cell feature for each one of a plurality of network cells, the cell feature representing a cell state of respective network cell, may comprises the method step of:

S211 receiving at least one cell feature from each network cell, wherein the at least one cell feature of respective network cell is transmitted by a network node serving respective network cell. It is appreciated that information regarding the at least one cell feature does not have to be transmitted directly from the network node, but that the information may be relayed and/or intermediately stored at/via some intermediate node.

As also illustrated in FIG. 4, according to examples of the disclosure, the method may further comprise: S250 providing information to the network nodes serving the network cells from which at least one cell feature has been obtained and for which at least one action (a) to be performed has been determined, enabling respective network node to (if required) perform said at least one action (a). For further clarification, the method step of S250 providing information to the network nodes serving the network cells may further comprise the method step of:

S251 transmitting information towards, or directly to, network nodes serving the network cells, for which at least one cell feature has been obtained and for which at least one action (a) to be performed has been determined, enabling respective network node to, if required, perform said at least one action (a).

It should be noted that in this context performing no actions or continue to perform one or multiple already initiated or ongoing actions, is also considered to fall under the method step referred to as performing an action (a).

According to one example of the present disclosure the information transmitted may also include an indication, for example by setting a flag in a message, of that the at least one action (a) should be performed. Thus, optionally the method step of 250/S251 may also comprise:

S252 providing, for example by means of transmitting, information to, or towards, network nodes serving the network cells, for which at least one cell feature has been obtained and for which at least one action (a) to be performed has been determined, causing respective network node to perform said at least one action (a).

According to yet one example of the present disclosure, the method step of S240: determining at least one action (a) to be performed for configuring at least one operation parameter for a number of network cells 140 of respective cell cluster 160, based on the at least one cell feature of the representor cell 170 of the concerned cell cluster 160, may be performed using a Reinforcement Learning, RL, agent.

Reinforcement Learning, RL, is a long-established sub-category of Machine Learning, ML, for decision-making. In RL an RL agent interacts with an environment by exploring a number of states (sn) and selecting actions (aₙ), starting from a state (s), to maximize a long-term return of its actions (aₙ). Performing an action (a) leads to that the RL agent arrives at a new state (s). For every action (a) performed a reward (r) is calculated.

The skilled person will be familiar with that RL, and RL agents, may be set-up and implemented in numerous ways depending on the context, requirements and/or restrictions. Prior art discloses a number of RL techniques implementing for example model-based agents, value-based agents, policy-based agents, actor-critic agents or model-free agents. When defining an RL problem, depending on the RL technique used, there are numerous value functions; applied to predict the value of actions an RL agent may take, transition, or probability distribution, functions; defining the probability to transition from one state to another based on the action of an RL agent, model functions; providing a model of the environment the RL agent is acting in, and reward functions; incentivizes or penalizes specific states and/or state-action pairs, that for example may be used. Further, one commonly applied method is to model an RL problem as a Markov Decision Process, MDP.

The skilled person will further be familiar with that which particular RL technique that should be applied, how various hyperparameters are tuned etc. is dependent on various parameters such as for example available hardware, the nature of the data available and the particular use case. It is not within the scope of this disclosure to explain basic RL methodology, but merely to disclose how basic RL techniques can be applied to provide methods for network configuration in dense networks. However, for reason of clarity, a number of exemplary, not exhaustive, high-level exemplary implementations, and aspects to consider when setting up an RL agent, are disclosed herein.

According to examples of the disclosure, an RL problem may be defined by, or modelled by means of:
a state space(S): set of all possible states, herein generally referred to as states (sₙ), where (sₙ)∈(S), and
an action space (A): set of all possible actions, herein generally referred to as actions (aₙ), where (aₙ)∈(A).
a management policy TT, which can be model-based or model-free.

Additionally, setting up an RL problem may comprise various components such as for example;
a transition probability distribution (P): probability to transition from one state to another based on the action of the RL agent,
a reward function (R): incentivizes or penalizes specific state-action pairs, thus predicts the reward (r) performing an action (a), leading to transition to a specific state (s), will generate, and
a value function (V); applied to predict the value of an action an RL agent may take,
   just to mention a few possible components.

What herein generally is referred to as the transition probability distribution (P) is sometimes referred to as transition function (T). These terms can be used interchangeably. Reward function (R) may also be referred to as reward distribution (R). These terms can also be used interchangeably.

In general terms, the RL interaction proceeds as follows: at each time instant t, the agent finds itself in a state (sₜ), where sₜ∈S, selects an action (aₜ) based on for example the policy π, where (aₜ)˜π(⋅|sₜ)∈A, receives a stochastic reward rₜ˜R(⋅|sₜ, aₜ) for performing such action (aₜ), and transitions to a new state sₜ₊₁˜P(⋅|sₜ, aₜ).

For RL techniques applying a management policy π, the policy π of an RL agent defines the control strategy applied by the RL agent and provides a mapping from states (sₙ) to distribution over actions (aₙ). An initial policy π may for example by derived an off-line training, trial-and-error fashion by using previously collected. The goal of an RL agent is generally to find the optimal policy π, thus. a policy that maximizes the expected cumulative rewards (r) over time. Rewards (r) expected to be rewarded later in time are generally discounted.

During training of a RL agent applying a management policy π, using previously collected communication network data, the training data available may be divided in a training data set and a testing data set, and training may be performed for example until a predetermined minimum RL agent performance is guaranteed, or a performance threshold is reached. During execution of examples of the present disclosure, the policy π may either be continuously updated as the method is executed, thus on-line, or the policy π may be re-trained off-line. Re-training may for example be triggered by that the performance level of the method falls below the predetermined performance threshold. It is also possible to, in parallel to running the method, continuously re-train, or continue to train, the RL agent off-line so that when re-training is triggered an improved RL agent immediately may be implemented.

The skilled person will recognize that the present disclosure may also be deployed using RL techniques not relying on a policy π, such as for example a value-based technique relying primarily on a value function.

While executing this dynamic optimization process in unknown environment (with respect to for example transition and reward probabilities), it may be preferable that the RL agent sometimes tries out and explores different state-action combinations often enough to be able to make accurate predictions about the rewards and the transition probabilities of each state-action pair, and that the agent also explores potential new state-action pairs. Thus, it may be preferable that the agent repeatedly chooses suboptimal actions, which short term conflicts with its goal of maximizing the cumulative reward (r). This may for example be achieved by applying a stochastic policy. At each time step, the agent may decide whether to prioritize further gathering of information (exploration) or to make the best move given current knowledge (exploitation). The ratio between exploration and exploitation, thus the propensity to try to improve the current policy π in relation to proposing optimal action (a) given the current policy π, is a hyperparameter that may be set case by case, for example by considering the potential damage, performance degradation etc. by exploring a not optimal action.

Examples of RL models may include Q-learning, State-Action-Reward-State-Action, SARSA, Deep Q Network, Policy Gradient, Advantage Actor-Critic, A2C, Asynchronous Advantage Actor-Critic, A3C, just to mention a few.

Below follows an exemplary disclosure highlighting various examples of the disclosure of how RL may be implemented when being applied in the context of the present disclosure.

According to examples of the present disclosure, the Reinforcement Learning, RL, agent is a policy-based RL agent, or any other RL agent applying a management policy π, wherein the RL agent determines at least one action (a) to be performed based on a Reinforcement Learning, RL, agent policy π. The Reinforcement Learning, RL, policy π provides a strategy, also referred to as mapping or framework, for suggesting suitable actions (aₙ) given a current state (s) of the environment the Reinforcement Learning, RL, agent is acting in, thus the network cells of the communication network. The state (s) of a network cell is defined by the cell features of respective network cell. By applying the Reinforcement Learning, RL, policy π, the RL agent is capable of suggesting, or determining, at least one action (a) to be performed by a network node for a network cell given a current state (s) of the network cell. For respective action (a) performed a reward (r) is calculated per network cell.

Thus, for such examples, when applying RL in the context of the present disclosure:
a state (s) is defined by the cell state of the representor cell,
the at least one action (a) to be performed corresponds to an action (a) to be performed by respective network node, in a number of network cells, for configuring at least one operation parameter in a network cell served by respective network node, and
a reward (r) is calculated per network cell based on the outcome of the network node performing said action (a).

According to examples of the present disclosure, the action (a) taken may be at least one of: changing an antenna transmitting direction (a_{RET}) of a Remote Electronic Tilt, RET, antenna a quantified or predetermined angle up, down, left or right, setting an hysteresis parameter (a_{HP}) in an Radio Resource Control, RRC, configuration message, determining Modulation and Coding Scheme, MCS, profile (a_{MCS}), and/or configuring filter settings (a_{FS}), just to mention a few. Many Radio Resource Control, RRC, actions of a network cell depend on the filtered measurements. Filtering the received measurements depends on the filter settings. To give one example; the Reference Signal Received Power, RSRP, measurements received from a wireless device may be averaged on a time window before triggering an RRC action such as handover.

It should be noted that “suggesting” ( . . . at least one action (a) . . . ) and “determining” ( . . . at least one action (a) . . . ) are herein generally used interchangeably, although obviously not actually having the same meaning. A person skilled in the art will be familiar with prior art solutions for safe RL, thus solutions aiming to determine if it is safe to perform actions suggested by an RL agent. For reason of simplicity, when herein discussing the present disclosure, we assume that actions (aₙ) suggested by an RL agent also are performed, thus this can be seen as that the RL agent “determines” actions (aₙ) to be performed. However, obviously aspects of the present disclosure may be combined with prior art methods of implementing RL in a safe manner.

Calculating reward per network cell corresponds to calculating reward per network node since we herein consider one network node to provide radio coverage to one network cell.

In general terms, the reward (r) is calculated by taking a number of selected KPIs in consideration, herein the selected KPIs are referred to as being provided in/by the performance metric. Thus, the reward (r) may be calculated be means of a performance metric applicable to determine if, and to what extent, an action (a) performed led to a desirable outcome, in other words, which effect the action (a) had in respect to selected KPIs. Thus, according to examples of the disclosure, for every action (a) performed by a network node for a network cell a reward (r), indicating an observed impact of performing the action (a) given the current state (s) of the network cell, is calculated based on a performance metric. The performance metric is applicable to define if and/or how favorable the outcome of an action (a) performed was given a predefined goal of performing the action (a). The KPIs may comprise attributes of a network cell, a network node, at least a portion of a communication network or any combination thereof. The reward (r) provides an indication of if and/or to what extent the outcome of the action (a) performed was favorable, given the performance metric. Thus, to give an example, the performance metric may for example define that the reward is to be calculated by taking throughput of a network cell, throughput of an entire communication network, and a parameter from which energy consumption can be derived of a network node, in consideration, wherein that throughput of the network cell and over the entire communication network should be high and the energy consumption should be low, to be rewarded a high reward (r) value. In some examples of the disclosure, the performance metric may include weighting factors for respective element of the performance metric. According to one example of the disclosure, the reward (r) may be calculated by applying a function of at least the performance metric.

According to other examples of the disclosure, the performance metric may comprise at least one, or any combination, of: (uplink and/or downlink) throughput of the network node, Quality of Service, QoS, experienced for operation over the network node, number of measurements performed and/or reported by at least one wireless device served by the network node or multiple wireless devices of a network cell, net-power consumption or saving of the communication system and/or a single network node, uplink and/or downlink Signal-to-Interference-and-Noise Ratio, SINR, between one or a plurality of network node(s) and a wireless device(s), and/or Radio Link Control, RLC, failure.

According to examples of the disclosure, the Reinforcement Learning, RL, agent may be a model-based agent using Deep Neural Networks, DNN, what generally is referred to as a Deep Reinforcement Learning, DRL, agent.

The cell features of a network cell characterize respective network cell at a time t. If for example being measurable values or parameters that changes rapidly, the cell features may be valid only at the time t. Thus, the at least one action (aₜ) to be performed at time t is determined based on at least one cell feature characterizing respective network cell at a time t. This is referred to as the state (sₜ) at time t. The reward (rₜ) calculated is calculated for the at least one action (aₜ) performed at time t. When performing the at least one action (aₜ) the system transitions from state (sₜ) to state (sₜ₊₁). When the method of the present disclosures is repeated the cell features extracted will characterize respective network cell at time t+1, thus, characterizes the network cell when being in state (sₜ₊₁). A new action (aₜ₊₁) will be determined by the RL agent, and a new reward (rₜ₊₁) will be calculated after performing the new action (aₜ₊₁). Examples of the present disclosure of when the method may be repeated are further discussed below.

As previously mentioned, according to examples of the disclosure, the method step of S220 clustering a number of network cells into a number of cell clusters, wherein the clustering of network cells is performed based on the obtained at least one cell feature of respective network cell, may comprise the method steps of:
S221 calculating a Joint Probability Density Function, JPDF, and
S222 using the calculated Joint Probability Density Function, JPDF, to cluster the network cells.

S221 and S222 of FIG. 4 corresponds essentially to steps S2 and S3 of FIG. 2c. In some examples of the disclosure, the method step of S221 calculating a Joint Probability Density Function, JPDF, may be performed using one of: Kernel Density Estimation, KDE, technique, histogram smoothing, or any method know to the person skilled in the art. The method step of S222 using the calculated Joint Probability Density Function, JPDF, to cluster the network cells, may for example be performed using one of: Self-Organizing Maps, SOM, technique applying Kullback-Leibler, KL, divergence distance metric, or any suitable variation of Euclidian distance metric, or k-Nearest Neighbor Classifier, k-NNC, technique using any suitable variation of Euclidian distance metric. The Probability Density Function, PDF, is a function whose value at any given sample (or point) in the sample space (the set of possible values) provides a relative likelihood that the value of the variable would equal that sample. The integral of the PDF of a continuous variable over an interval is equal to the probability that the variable belongs to that interval. The PDF over a vector of continuous variables can be characterized by a Joint PDF, JPDF, of its variables.

It is appreciated that when referring to that “a number of network cells”, generally this is considered to comprise all network cells for which the control node has been provided with cell features. However, there may be situation where one, or a number of network cells, are excluded from being included in the clustering. This may for example be the case if a network cell, or a network node of a network cell, provide mission critical services. Thus, according to examples of the disclosure, all network cells for which the control node has obtained cell features are clustered into cell clusters.

According to one example of the present disclosure, each cell feature constitutes one element of a state vector, whereby a JPDF can be estimated for the state vector. Thus, the complete description of a network cell can be provided by the JPDF of the state vector of that network cell. As previously touched upon in relation to FIGS. 2b and 2c, a network cell is a stochastic environment which, according to embodiments of the disclosure, may be completely described by the JPDF of parameter values, herein generally referred to as cell features, of the network cell. Two different network cells may be similar in terms of respective JPDF, given that the environmental state of respective network cell is similar.

According to further examples of the present disclosure, the method step of S230 determining one network cell of respective cell cluster to be a representor cell of respective cell cluster, is based on one of: randomly selecting one network cell of all the network cells of the cell cluster, selecting the network cell being located closest to the geographical center of the cell cluster, or randomly selecting one of a number of the network cells being located closest to the geographical center of the cell cluster. Needless to say, here only network cells for which an actions (aₙ) is determined are considered. If selecting the network cell being located closest to the geographical center of the cell cluster is used as method to determine representor cell, and two or more network cells are equally distanced, or essentially equally distanced given a predetermined accuracy threshold, from the geographical center, one of those network cells can be selected randomly. In some examples of the disclosure, one of predetermined number of network cells, being located close to the geographical center of the cell cluster, may also be selected randomly.

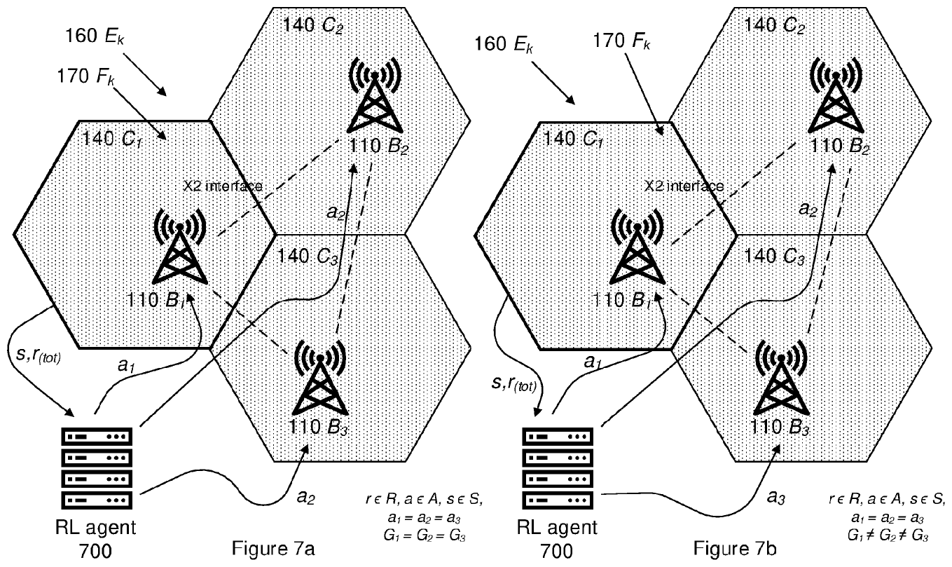

Referring now to FIGS. 7a and 7b, illustrating an exemplary implementation of the present disclosure, in relation to detecting inter-cell conflicts.

FIG. 7a shows three network nodes 110 B₁, 110 B₂ and 110 B₃ in k^{th} cell cluster 160 Eₖ having performance goals G₁=G₂=G₃. According to the example of the disclosure of FIG. 7a each network cell 140 C₁, 140 C₂ and 140 C₃ is provided with one network node 110 B₁, 110 B₂ and 110 B₃ each. The state (s) of respective network cell 140 C₁, 140 C₂ and 140 C₃, corresponds to the state (s) of network nodes 110 B₁, 110 B₂ and 110 B₃, and are similar since they belong to the same cell cluster 160 Eₖ. In accordance with methods disclosed herein, a representor cell 170 Fₖ of the cell cluster 160 Eₖ has been determined. When executing the method, the representor cell 170 Fₖ provides state information, thus state (St) at time t, or the cell features characterizing the representor cell 170 Fₖ at time t, to an RL agent 700.

The RL agent 700 subsequently chooses an action (aₜ)∈(A), from an action space (A). Information enabling the action (aₜ) to be performed by respective network node 110 B₁, 110 B₂, 110 B₃ is provided to respective network cell 140 C₁, 140 C₂, 140 C₃. After the determined action (aₜ) is performed a reward (rₜ) is calculated for respective network cell 140 C₁, 140 C₂, 140 C₃, and provided to the representor cell 170 Fₖ of the cell cluster 160 Eₖ. The representor cell 170 Fₖ aggregates the provided rewards (r_{n,t}) and feds back the cumulative reward (r_{tot,t}) to the RL agent 700. As a result of performing the action (a) at time t, respective network cell 140 C₁, 140 C₂, 140 C₃ transition from state (s) to state (sₜ₊₁), (not visualized) and the RL agent 700 is provided with the updated state information state (sₜ₊₁) of the representor cell 170 Fₖ. The cumulative reward (r_{tot,t}) will be positive if the network nodes 110 B₁, 110 B₂, 110 B₃ experience an overall improvement in their respective network cell 140 C₁, 140 C₂, 140 C₃. If the goal of respective network cell 140 C₁, 140 C₂, 140 C₃ is essentially the same, as is illustrated in FIG. 7a, thus G₁=G₂=G₃, the cumulative reward (r_{tot,t}) will simply be the sum of all individual rewards (r_{1-3,t}) calculated for network cell 140 C₁, 140 C₂, 140 C₃. FIG. 7b schematically illustrates the case where respective action (aₜ) performed by all the network nodes 110 B₁, 110 B₂, 110 B₃ within the same cell cluster 160 Eₖ results in that at least one network cell 140 C₁, 140 C₂, or 140 C₃ experiencing an impairment in the network cell due to performing the action (aₜ), thus, the reward (r) will be negative, whereas the other network cells experience an improvement, resulting in a positive rewards (r). This is referred to as intra-cell cluster conflict. In such a scenario, performing the same action (aₜ) in all network cells 140 C₁, 140 C₂, 140 C₃ in the cell cluster 160 Eₖ is not a desirable and requires conflict handling. This may for example be the case if the goals of the network cell 140 C₁, 140 C₂, 140 C₃ of a cell cluster 160 Eₖ is not the same, thus G₁≠G₂≠G₃. Respective reward (r) is reported to the representor cell 170 Fₖ of the cell cluster 160 Eₖ, whereby the representor 170 Fₖ aggregates the reported rewards (r) to a cumulative reward (rₜₒₜ). The reward (r) is generally provided as a numerical value, and the cumulative reward (rₜₒₜ) may simply be the sum of the reported rewards (r), whereby the cumulative reward (rₜₒₜ) will be lower if at least one network cell 140 C₁, 140 C₂, or 140 C₃ reports a negative rewards (r), or—as will be disclosed more in detail below—a sub-method with the purpose of detecting intra- or inter-cell conflicts may be performed. The cumulative reward (rₜₒₜ) will be reported to the RL agent 700, potentially together with an indication of intra- or inter-cell conflicts.

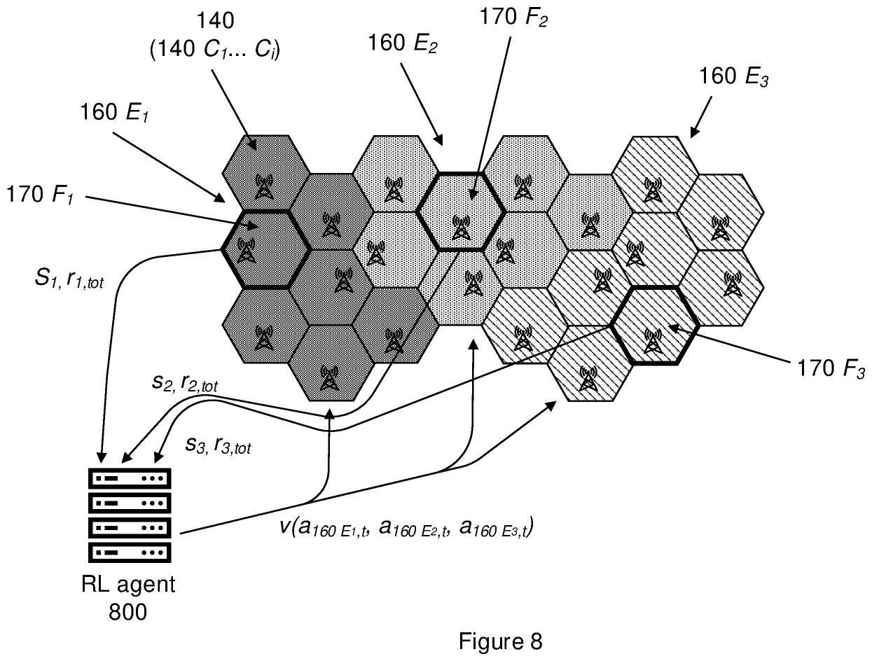

As previously mentioned, the method step of determining at least one action (a) to be performed for configuring at least one operation parameter for all network cells of respective cell cluster, based on the at least one cell feature of the representor cell of the concerned cell cluster, is performed using a Reinforcement Learning, RL, agent. The RL agent can either be a Local RL agent where each cell cluster is provided with one RL agent each, as illustrated in FIGS. 7a and 7b, or alternatively the RL agent may be a Master RL agent, being responsible for determining actions to be performed for multiple cell clusters. This is schematically illustrated in FIG. 8.

In the examples of the disclosure of FIGS. 7a and 7b, Local Reinforcement Learning, RL, agents 700 are applied. Thus, according to examples of the present disclosure the Reinforcement Learning, RL, agent is a Local Reinforcement Learning, RL, agent 700, wherein each cell cluster is provided with a Local Reinforcement Learning, RL, agent 700. According to examples of the disclosure, the Local RL agent 700 may be implemented at one of the network nodes of respective cell cluster, preferably at the network node 110 B₁ of the representor cell 170 Fₖ. (Please note that this is not shown in FIGS. 7a and 7b.) When the RL agent is a Local RL agent 700 the method step of: S240 determining at least one action (a) to be performed for configuring the at least one operation parameter for a number of network cells 140 of respective cell cluster 160, based on the at least one cell feature of the representor cell 170, is performed at a network node 110, preferably the network node 110 B₁ of the representor cell 170 Fₖ.

According to alternative examples of the present disclosure, the Reinforcement Learning, RL, agent is a Master Reinforcement Learning, RL, agent. An example of the disclosure implementing a Master RL agent is schematically illustrated in FIG. 8.

When applying a Master RL agent 800, the Master RL agent 800 receives state information of the entire geographical region, in FIG. 8 schematically illustrated by that all the cell clusters 160 E₁, 160 E₂, 160 E₃ provides input, thus at least one cell feature of respective representor cell 170 F₁, 170 F₂, 170 F₃, of respective cell cluster 160 E₁, 160 E₂, 160 E₃, to the Master RL agent 800. This features put together will form a vector of states(s_{(170 F1,t)}, s_{(170 F2,t)}, s_{(170 F3,t)}), v(states(s_{(170 F1-3,t)})), of cell features characterizing not only one, but multiple representor cells, at time t. Thus, an advantage of implementing a Master RL agent is that a Master RL agent may consider the state, represented by cell features, of each cell cluster as an attribute in the state vector v(states(s_{(170 F1-3,t)})) representing the state (s) when determining action (a).

The Master RL agent 800 produces a vector of action(a_{(160 E1,t)}, a_{(160 E2,t)}, a_{(160 E3,t)}), v(action(a_{(160 E1-3)})), with each element in the action vector v(action(a_{(160 E1-3,t)})) being the action, or sequence of actions, suggested by the Master RL agent 800 to each network node (not shown in FIG. 8) of respective cell cluster 160 E₁, 160 E₂, 160 E₃. For clarification, the clustering of network cells 140 (140 C₁, . . . , Cᵢ; where i=1, . . . , n) into a number of cell clusters 160 E₁, 160 E₂, 160 E₃ has preferably been performed in accordance with what previously has been disclosed. As for when applying a Local RL agent of FIGS. 7a and 7b, according to examples of the present disclosure the reward (rₜ) of performing the actions (a_{n,t}) is calculated per network cell 140 C_{1 . . . i}. The reward (rₜ) of respective network cell 140 C_{1 . . . i}, of respective cell cluster 160 E₁, 160 E₂, 160 E₃, is subsequently provided to the representor cell 170 F₁, 170 F₂, 170 F₃ of respective cell cluster 160 E₁, 160 E₂, 160 E₃, whereby respective representor cell 170 F₁, 170 F₂, 170 F₃ can aggregate the rewards (r_{tot,t}) to a cumulative reward (r_{tot,t}) of respective cell cluster 160 E₁, 160 E₂, 160 E₃. The cumulative reward (r_{tot,t}) is subsequently provided by respective representor cell 170 F₁, 170 F₂, 170 F₃ to the Master RL agent 800. In accordance with what previously has been disclosed, the method may subsequently be repeated at time at time t+1.

Thus, according to examples of the present disclosure, where the Reinforcement Learning, RL, agent is a Master Reinforcement Learning, RL, agent 800, the at least one action (a) to be performed for configuring at least one operation parameter for number of network cells 140 of respective cell cluster 160 is provided by the Master Reinforcement Learning, RL, agent to respective network cell 140 (or to the representor cell 170 of respective network cluster 160, in turn distributing information regarding actions to the network cells 140 of respective cell cluster 160) as a vector of v(actions (aₙ)). The Master RL agent 800 may be implemented in the control node (not shown in FIG. 8).

When the RL agent is a Master RL agent 800 the method step of: S240 determining at least one action (a) to be performed for configuring the at least one operation parameter for a number of network cells 140 of respective cell cluster 160, based on the at least one cell feature of the representor cell 170, is performed at the control node, such as for example a remote server or in a cloud architecture solution.

For further clarification, once again looking at rewards (r) being calculated per network cell and being aggregated at respective representor cell to a cumulative reward (rₜₒₜ).

Determining actions to be performed for all network cells of a cell cluster either results in that the outcome is favorable for all individual network cells of the cell cluster, or that the outcome is only favorable for a certain number of network cells.

As schematically illustrated in FIG. 7a, the former situation may occur when the goals, a goal being for example optimizing particular KPI(s), such as for example throughput and QoS for wireless devices currently being provided service by a network node of the network cell, of each network node in a cell cluster is the same, whereas the latter situation may occur when the goals of respective network node in a cell cluster is different, schematically illustrated in FIG. 7b. Thus, generally, if the goals of all network cells, given the operation parameter(s) the method is applied to configure, are the same, the outcome of performing an action of configuring the operation parameter(s) will provide the same, positive or negative, outcome.

Herein a not favorable outcome of performing an action for (at least) one network cell is referred to as conflicting outcome, since the outcome is in conflict with performing the action for (at least one) other network cell of the cell cluster. Conflicting outcome of performing an action of at least one network cell of a cell cluster is also simply referred to as conflict. As previously discussed, according to examples of the present disclosure, if the outcome of performing an action is favorable can be determined by looking at the reward calculated after performing the action.

Thus, according to examples of the present disclosure, referring to detecting intra-cell cluster conflicts, there is provided a method comprising:
S260 detecting conflicting outcome of performing said at least one action (a) in network cells, of a cell cluster, by evaluating, or comparing, the rewards (rₙ) calculated for respective network cell of the cell cluster.

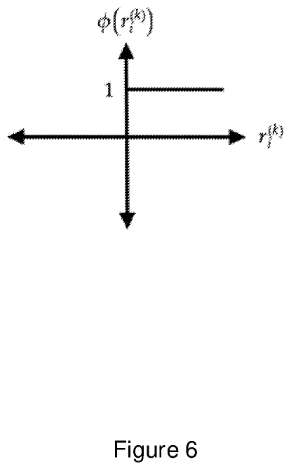

It is appreciated that detecting at least one conflicting outcome, or conflicting outcomes, may be performed in various ways, of which one preferred example of the disclosure is shown in FIG. 6 and disclosed in detail below.

According to this example, positive, as well as the negative, reward (rᵢ^{(k)}) of the i^{th} network node of nₖ network nodes of the k^{th} cluster, i∈n, is mapped to either a 1 or a 0 using a Unit Step Function, USF, as shown in FIG. 6. Then we define yₖ as follows:

$${y}_{k} = {\sum }_{i = 1}^{{n}_{k}} ϕ ( {r}_{i}^{( k )} ) \qquad ( 3 )$$

nₖ is the number of network nodes in cluster k. If yₖ<nₖ, then a conflicting outcome is detected in the cluster k, thus, not all rewards (rₙ^{(k)}) calculated for an action (a) (or sequence of action (aₙ) are positive.

Put another way, for all network cells nₖ of a cell cluster k a positive reward (r) is assigned a value of y=1 and a negative reward (r) is assigned a value of y=0, and wherein all assigned values are summed up as yₖ, and wherein if yₖ<nₖ conflicting outcome, of performing an action (a), in a cell cluster is detected.

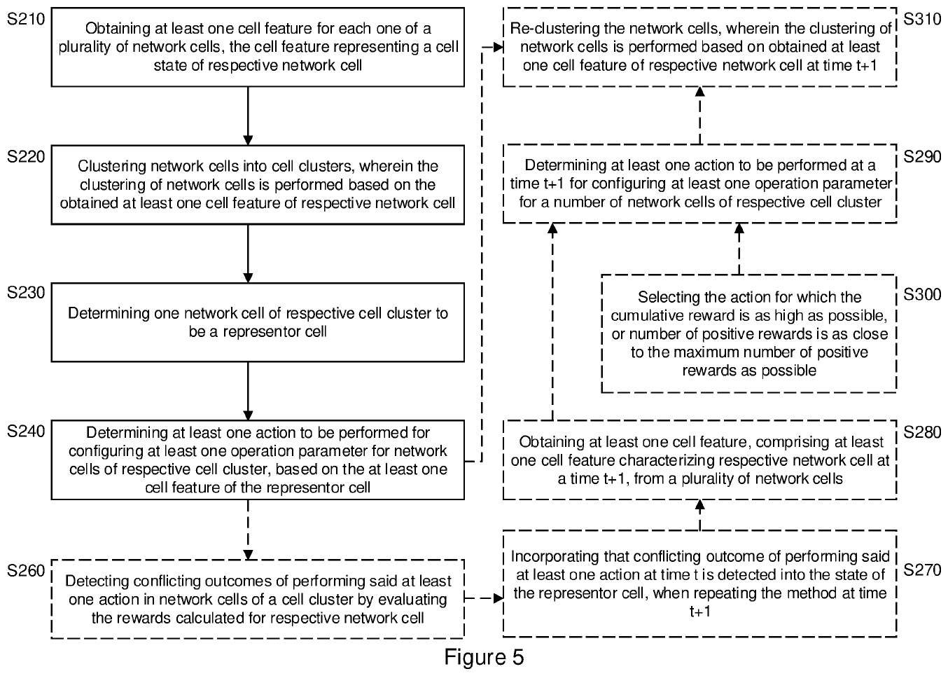

This information, thus that performing a particular action (aₜ), given a certain state (sₜ), at time t does not provide a positive reward (rₜ) for at least one network cell, may be embedded into the state (sₜ₊₁) of the cell cluster which is used as input to next iteration of the RL agent, thus when executing the method at time t+1. Thus, in some examples of the present disclosure, schematically illustrated in FIG. 5, there is provided a method comprising:
S270 incorporating that conflicting outcome of performing said at least one action (a) in network cells of a cell cluster at time t is detected into the state (s) of the representor cell, when repeating the method at time t+1.

If a conflicting outcome of performing an action (aₜ) in a network cell of a cell cluster has been detected it is obviously desirable to determine a new action (aₜ₊₁) to be performed, hopefully not leading to conflicting outcome.

Thus, according to further examples of the disclosure, methods of the disclosure further comprise:
S280 obtaining at least one cell feature, comprising at least one cell feature characterizing respective network cell at a time t+1, for a plurality of network cells, the cell feature representing a cell state of respective network cell, embedding the detected conflicting outcome, or that a conflicting outcome has been detected, and
S290 determining at least one action (a) to be performed at a time t+1 for configuring at least one operation parameter for a number of network cells of respective cell cluster.

As previously disclosed, according to examples of the disclosure, the method step S290 may be performed using a Reinforcement Learning, RL, agent.

Still referring to FIG. 5, according to examples of the disclosure, when conflicting outcome has been detected the RL agent may be configured to instead select one, or a sequence of, action (a)/actions (aₙ) that makes yₖ as close as possible to nₖ. However, this will still result in sub-optimal policy for the RL agent, because the new set of actions (aₙ) chosen may be sub-optimal for the network nodes whose goals were not in conflict with any other network node.

This is described by the following equation (please note that a slightly different indexing is applied in the example below):

$${a}_{m}^{* ′} \approx arg max \text{?} {\sum }_{i = 1}^{\text{?}} 𝔼 ( ϕ ( {r}_{i}^{m} ( {x}_{m} , {a}_{m} , {w}_{m} ) ) + {\sum }_{j = m + 1}^{N} ϕ ( {r}_{i}^{j} ( {x}_{j} , {a}_{j} , {w}_{j} ) ) ) \qquad ( 4 )$$

$$\text{?} \text{indicates text missing or illegible when filed}$$

where aₘ*′ is the sub-optimal action (a) chosen by the RL agent, (xₘ, aₘ, wₘ) triplet is the state (s), action (a), and random disturbance at time m, rᵢ is the one-step reward (r) for the i^{th} network node in the cell cluster, E(.) is an expectation operator, as is commonly known from statistics, over the random disturbance and the random state.

Thus, according to examples of methods of the disclosure, the methods further comprise:
S290 determining at least one action (a) to be performed at a time t+1 for configuring at least one operation parameter for a number of network cells of respective cell cluster,
   is performed by:
S300 selecting the action (aₜ₊₁) for which the cumulative reward (r_{tot,t}) of the cell cluster is as high as possible, or, with other words, the number of positive rewards (rₜ) is as close to the maximum number of positive rewards (rₙ) as possible, wherein the maximum number of positive rewards (rₜ) is the same as number of network cells nₖ, thus, referring to the example above, yₖ is as close to nₖ as possible. The cumulative reward (r_{tot,t}), also referred to as aggregated or consolidated reward (r_{tot,t}), is the sum or aggregation of all reward (r_{n,t}) calculated at time t for the network cells in which the action (aₜ) was performed, for a cell cluster.

In accordance with what previously has been disclosed, the method step 290 may be performed using a Reinforcement Learning, RL, agent.

According to further examples of the disclosure, instead of, or in addition to, determining that a sub-optimal action is to be performed the method may be configured to re-cluster the network cells into new cell clusters. The number of new network cells may be, but is not limited to be, same as the number of previous network cells.

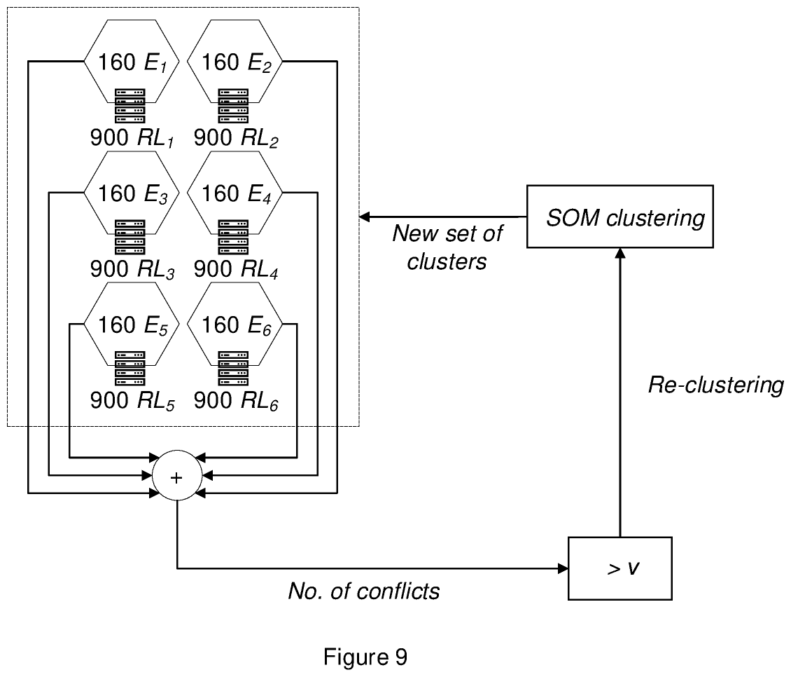

Referring now to FIG. 9, schematically illustrating a data-driven approach for handling intra-cell cluster conflicts. According to this example of the disclosure, initially, there are six cell clusters 160 E₁₋₆ with one Local RL agent 900 RL₁₋₆ deployed per cell cluster 160 E₁₋₆. In one example of the disclosure, a representor cell (not shown) is determined for each cell cluster 160 E₁₋₆ and at least one action (a) is determined for all network cells of respective cell cluster 160 E₁₋₆. When executing the method, each RL agent 900 RL₁₋₆ determines the same action (a), or sequence of actions, to be performed by all network nodes within respective cell cluster 160 E₁₋₆, which this may result in conflicts as previously discussed. The total number of conflicts across all the cell clusters 160 E₁₋₆ are considered and compared against a threshold value v. If the total number of conflicts detected is above the threshold value v, then re-clustering of all network cells 160 E₁₋₆ is initiated. In this way the system is capable of handling situations where network nodes in cell cluster 160 E₁₋₆ see degradation in the performance due to the action selected by respective RL agent 900 RL₁₋₆.

Two examples of re-clustering are disclosed below.

According to an example of the present disclosure, a method is provided comprising that if the total number of intra-cell conflicting outcomes, or conflicts, detected in a plurality of cell cluster, exceeds a threshold value v, re-clustering is triggered. The threshold value v may for example be set by iteratively evaluating the overall performance of the method for different threshold values until a desired performance level is reached. The threshold value v may also be used to tune the performance and/or properties of the communication network.

For clarification, if one considers the method of the present disclosure to be executed at a time t, then obviously method steps relating to re-clustering (and repeating examples of the disclosure of the method disclosed herein) are performed subsequently, thus at a time t+1. Thus, according to examples of the present disclosure, there is provided a method further comprising the method step of: at the time t+1 S310 re-clustering the network cells, wherein the clustering of network cells is performed based on obtained at least one cell feature of respective network cell at time t+1.

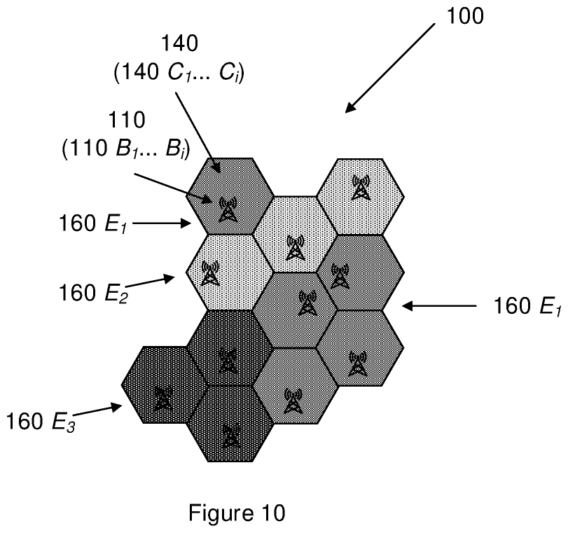

Referring now to FIG. 10, schematically illustrating an example of the disclosure of inter-cell cluster conflict handling. FIG. 10 illustrates a geographical area over which a communication system 100 provides radio coverage. The geographical area is divided into different network cells 140 (140 C₁, . . . , Cᵢ; where i=1, . . . , n), and each network cell 140 is served by a network node 110 (110 B₁ . . . . Bᵢ; where i=1, . . . , n). The network cells 140 are divided into different cell clusters 160 (160 E₁, E₂, E₃).

In general, this example of the disclosure refers to re-clustering of network cells 140 where conflicts between network nodes 110, of respective network cell 140, belonging to different cell clusters 160 of the communication network 100, are considered.

The method is defined below.

For each network node 110 Bᵢ for i=1, . . . , N_{c} define a set N_{g}(Bᵢ) as:

$$\begin{matrix}{N}_{g} ( {B}_{i} ) = \{ {l}_{j} : {d}_{( sort , ascend )} ( {B}_{i} , {B}_{j} ) for j \\ = 1 , … , K \}\end{matrix} \qquad ( 5 )$$

where N_{g}(Bᵢ) is a set containing labels lⱼ of K-nearest neighbor network nodes of Bᵢ and d (Bᵢ, Bⱼ) is the distance between network nodes Bᵢ and Bⱼ. The labels lⱼ indicate to which cell cluster respective network node, or network cell of network node, belongs. lⱼ ranges between 0 and the number of clusters, thus three in the example of FIG. 10. j represents the K-nearest neighbors that were picked as per equation (5).

Let θ(.,.) be a correlation metric, defining how two network nodes, belonging to network cells of different cell clusters, affect, or correlate to, each other. How the network nodes affect, or correlate, to each other is referred to as correlation effect.

In the example discussed below, interference will be used as correlation effect, or parameter affected by correlation between two network nodes, but the skilled person will recognize that the method is applicable also for other parameters.

The correlation metric θ(.,.) is a function of two network nodes for example θ(Bⱼ, Bᵢ) expressing the interference (correlation effect), caused by Bⱼ in Bᵢ, and define βᵢ as

$${β}_{i} = {\sum }_{\dot{l} ∈ {N}_{g} ( {B}_{i} )} θ ( {B}_{l} , . {B}_{i} ) ( 1 - δ ( {l}_{i} - l ) ) . \qquad ( 6 )$$

Subsequently, define the total interference (correlation effect) in the system, for example, as:

$$T = {\sum }_{i = 1}^{{N}_{B}} {β}_{i} . \qquad ( 7 )$$

Finally, calculate the convex combination value μ of intra-cell conflicts and total interference (correlation effect) caused by inter-cell conflicts by letting μ=πC+(1−γ)T, where γ is a hyperparameter between 0 and 1, thus 0≤γ≤1, T is the total interference (correlation effect) and C be the total number of intra-cell conflicts within the cell clusters. The number of intra-cell cluster conflicts may for example be determined by means of the data-driven approach for handling intra-cell cluster conflicts discussed in relation to FIG. 9.

According to embodiments, by applying the above method, re-clustering is triggered when μ≥γ.

Thus, according to examples of the present disclosure, the disclosure also refers to a method wherein, for at least a subset of the plurality of network nodes of network cells belonging to different cell clusters, the total number of inter-cell conflicting outcomes, or inter-cell conflicts, of performing at least one action (a) in respective network cell of the subset of the plurality of network nodes, are considered.

In examples of the present disclosure the method comprises the method steps of:
by means of a correlation metric providing the correlation, for example the interference, between each pair of network nodes of the subset of network nodes:
   calculating a total correlation effect, for example interference, caused by network nodes of the subset of network nodes,
   determining a number of intra-cell conflicts,
   calculating a convex combination value μ of number of intra-cell conflicts and total correlation effect of inter-cell conflicts, for example interference, and
   comparing the convex combination value μ against a threshold value δ, wherein if the convex combination value μ exceeds the threshold value δ, re-clustering is triggered.

As previously mentioned, it should be appreciated that when herein referring to selecting, suggesting or determining at least one action (a), that may in many situations actually be a set of actions (aₙ) that is selected, suggested or determined. Such actions may be performed simultaneously and/or in sequence. However, for reason of simplicity, herein we generally refer to at least one action (a) or actions (aₙ). It should be appreciated that action (a) and set of actions (aₙ) may be used interchangeably, and that examples of methods disclosed herein are just as applicable for selecting, suggesting or determining a set of actions (aₙ) as a single action (a).

Turning now to discussing the present disclosure from the perspective of a network node:

It is appreciated that examples of the disclosure of various methods performed by a control mode of the present disclosure, involving interaction with a network node, discussed from the perspective of a control node are mirrored by or for the network node. Hereafter, examples of methods from the perspective of a network node are discussed, and it is also appreciated that advantages previously discussed in relation to corresponding methods being performed by a control node also applies for respective example of the disclosure when being performed by a network node.

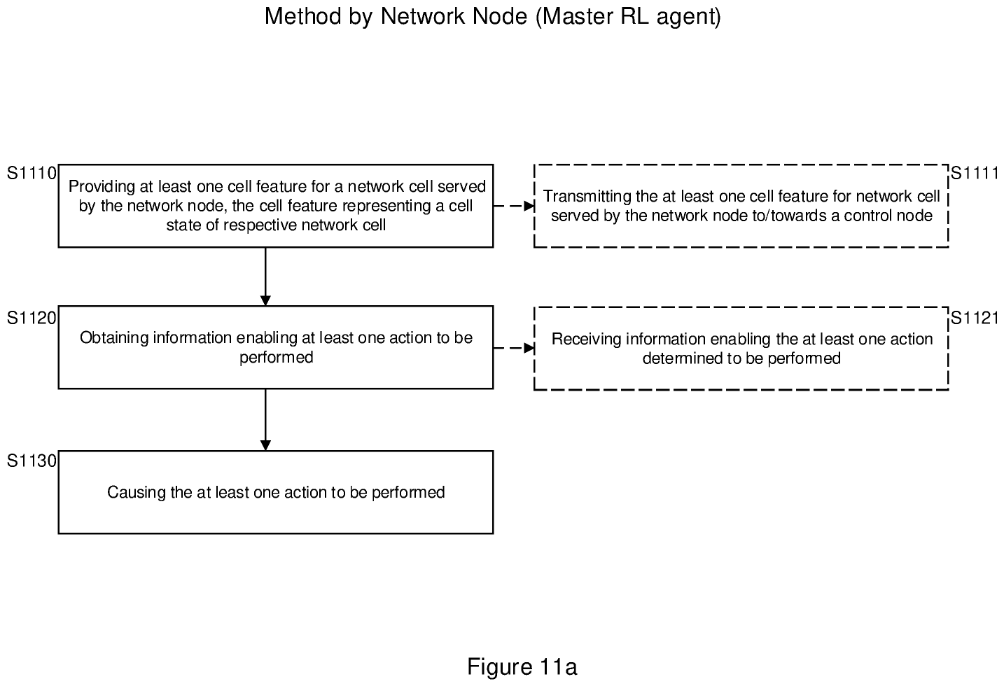

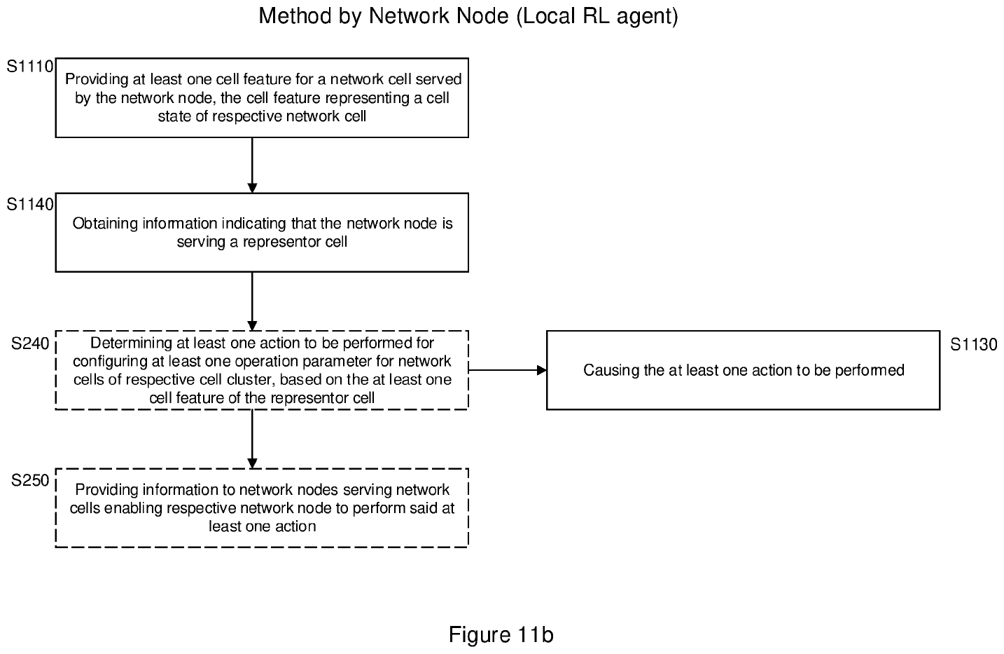

As previously mentioned, depending on if the RL agent is a Master RL agent, for example implemented in a control node, or a Local RL agent, implemented at a network node, the method step of determining least one action (a) to be performed may be performed either at the control node or at a network node. FIG. 11a schematically illustrates an flow chart disclosing a method where the RL agent is a Master RL agent, and FIG. 11b schematically illustrates a flow chart disclosing a method where the RL agent is a Master RL agent. It should however be noted that also a Master RL agent may be implemented in a network node.

For clarification, as will be discussed below, the physical or virtual entity herein referred to as control node may also be implemented in a network node. If so, the network node referred to below may be considered to be a second network node, whereas the control node is implemented in a first network node.

Referring now to FIG. 11a, disclosing a flow chart schematically illustrating a first example of the present disclosure, from the perspective of a network node. The example of the present disclosure provides a computer-implemented method, performed in a network node of a communication network, for configuring at least one operation parameter in a network cell served by the network node. According to embodiments where the control node is implemented in a first network node, the method is performed by a second network node. The network node may be a network node of a communication network comprising a Radio Access Network, RAN, connecting a plurality of network nodes, each network node serving at least one network cell.

The method comprises the method steps of:
S1110 providing at least one cell feature for a network cell served by the network node, the cell feature representing a cell state of the network cell,
S1120 obtaining information enabling at least one action (a), to be performed, and
S1130 causing the at least one action (a) to be performed.

Embodiments relating to further details of methods performed by network nodes will now be disclosed.

In further examples of the present disclosure, the method step of S1110 providing at least one cell feature for a network cells served by the network node, the cell feature representing a cell state of the network cell, may comprise the method step of S1111 transmitting the at least one cell feature for the network cell served by the network node towards, or directly to, a control node. The method step of S1120 obtaining information enabling at least one action (a), to be performed, may comprises S1121 receiving information enabling the at least one action (a) to be performed. By obtaining information enabling the at least one action (a) to be performed, the network node may additionally perform the method step of S1130 causing the at least one action (a) to be performed.

As mentioned, the present disclosure refers to examples of methods for configuring at least one operation para meter in a network cell served by a network node. According to the disclosure, the configuring of the at least one operation parameter is performed by executing an action (a), preferably determined by using an RL agent. There are several use cases for methods of the present disclosure. Thus, which at least one operation parameter that actually may be configured (or is determined to not be configured, thus that no action is to be taken) as a result of executing the method, can be one of many possible operation parameters. Operation parameters are herein considered to for example be parameters controlling an operation of a network node. Configurations of parameters may for example refer to configuring a mobility parameter, a power control parameters, a parameter affecting network cell configurations, Random-Access Channel, RACH, configuration, etc. Some examples of actions (aₙ) that may be determined, thus resulting in a configuration, or re-configuration, of an operation parameter, may for example one of a non-exhaustive list of: choosing tilt angle of at least one remotely controllable antenna of a network node, choosing hysteresis parameters for a handover operation, resource allocations and load balancing. To facilitate understanding of the present disclosure, we will now look at two of these use cases more in detail.

For clarification, when discussing the exemplary use cases, Base Station, BS, is used as alternative term for network node and User Equipment, UE, is used as alternative term for wireless device.

### First Exemplary Use Case: Antenna Tilt/Antenna Transmitting Direction

Remote Electrical Tilt, RET, is an operation in which antenna tilt angle, or antenna transmitting direction, of a remotely controllable antenna at a BS is adjusted remotely. Changing the tilt angle of an antenna of a BS does not only affect for example signal strength and signal quality of UEs currently being located in the coverage area of the BS, which may be, but does not have to be, equal to the network cell of the BS, or currently being served by that BS, but also affects UEs nearby the previous and/or new coverage area of the BS. Changing the antenna tilt angle may for example increase or decrease interference to services provided by neighboring BSs, just to mention a few of the effects of changing the tilt angle of a single antenna.

Consider an exemplary scenario where examples of the present disclosure are implemented to configure the operation parameter antenna tilt/antenna transmitting direction (@RET), and where we have three BSs in a cell cluster k, thus, nₖ=3 BS s in k^{th} cell cluster, and the action suggested by the RL agent is to tilt the antenna of one of the BSs to the right by a_{RET.1}*=5°. Tilting the antenna of a first BS could improve for example throughput and QoS for UEs currently being provided service by the first BS. However, for the second and the third BS this action of configuring the operation parameter antenna tilt angle/antenna transmitting direction (a_{RET}) could hamper the throughput and the QoS resulting in (referring to the denotations used above) yₖ<3. When repeating the method (for example at time t+1), thus during next iteration, the RL agent may instead for example determine an action a_{RET,1}*′ in such a way that instead of tilting the antenna by 5°, the BSs configures the operation parameter antenna tilt/antenna transmitting direction (a_{RET}) by a smaller, or larger, angle. This may result in a sub-optimal policy for the first BS, but may not affect the second and the third BS.

Thus, according to examples of the present disclosure the at least one of the operation parameter in at least one network cell configured may be antenna transmitting direction (a_{RET}), whereby the at least one action (a) to be performed for configuring the antenna transmitting direction (a_{RET}), is changing the direction of the antenna a quantified or predetermined angle up, down, left or right.

Applying examples of the present disclosure to configuring antenna tilt/antenna transmitting direction has the advantage that, in addition to optimizing or improving antenna tilt settings, by clustering network cells, followed by selecting one network cell to represent the cell cluster, whereby the state space(S), acting as environment for the RL agent, is significantly reduced. This leads for example to that less computational resources are needed, in turn leading to that less energy is consumed and to reduced latency.

Yet an advantage is that by implementing examples of the disclosure, also taking conflicting outcome of configuring the antenna tilt angle/antenna transmitting direction in consideration, not only the performance in one network cell is considered, but the overall performance of the communication network (thus, all the network cells affected by executing the method of the disclosure) may be considered when evaluating the outcome of configuring the antenna tilt angle/antenna transmitting direction. Evaluating the outcome of configuring the antenna tilt angle/antenna transmitting direction is done by calculating and considering the reward.

Thus, for the use case where the at least one operation para meter configured by performing the at least one action (a) is configuring antenna tilt/antenna transmitting direction, the present disclosure refers to:
a computer-implemented method for configuring (at least one operation parameter:) antenna tilt/antenna transmitting direction in a network cell served by a network node, the method comprising:
obtaining (at least one cell feature:) a parameter value representing for example throughput, inter-cell interference and/or QoS from each one of a plurality of network cells, (the cell feature representing a cell state of respective network cell),
clustering a number of network cells into a number of cell clusters, wherein the clustering of network cells is performed based on (the at least one cell feature:) the parameter value representing for example throughput, inter-cell interference and/or QoS of respective network cell,
determining one network cell of respective cell cluster to be a representor cell of respective cell cluster,
and for at least one, preferably each, cell cluster:
determining (at least one (action (a):) to change the antenna tilt/antenna transmitting direction of an antenna a quantified or predetermined angle up, down, left or right (to be performed for configuring at least one operation parameter) for a number of, preferably all, network cells of respective cell cluster, based on (the at least one cell feature:) the parameter value representing for example throughput and/or QoS of the representor cell.

### Second Exemplary Use Case: Setting of Hysteresis Parameter at Handover

In modern communication networks the hysteresis parameter, h, along with for example time-to-trigger, Γ, is used to overcome the ping-pong effect at handover. Whenever a UE is in connected mode, the BS sends a RRC configuration message to the UE, resulting in various measurements being performed by the UE and reported back to the BS. According to further examples of the present disclosure, based on at least one received cell feature from respective network cell of a cell cluster, the RL agent of a representor cell, can suggest an action (a): setting the hysteresis parameter, h*, value in the RRC configuration message for all the UEs connected to the BSs in the network cells of the cell cluster. The at least one cell feature may for example be at least one of a number of measurements made by UEs of respective network cell, such as for example: neighboring cell signal level, serving cell signal level, and/or the interference by the neighboring network cells. Note that when cell features of a network cell are measurements made by a UE, being served by a BS of the network cell, the measurement needs to be reported by the UE to the BS before the at least one cell feature, in this case UE measurement(s), can be reported to the control node by a network cell.

Thus, according to one example of the present disclosure the at least one of the operation parameter configured in at least one network cell is handover hysteresis, h*, whereby the at least one action (a) to be performed is setting (alternatively changing or updating) the handover hysteresis para meter, h* (alternatively increasing or decreasing a previously set hysteresis parameter value with a quantified or predetermined value), action (a_{HP}). As a consequence of such an action (CHP) the number of measurements made by the UEs could be reduced, in turn saving battery and reducing the load on the BS in terms of required computational resources and energy.

According to examples of the disclosure, suppose the hysteresis parameter, h*, suggested by the RL agent for a cell cluster results in conflicting outcomes, then the RL agent will, during a subsequent execution of the method of the disclosure, or when iterating the method, suggest a sub-optimal setting of the hysteresis parameter, thus h*′≠h*, as hysteresis parameter setting in the RRC configuration message. Therefore, upon completion of training, the RL agent will learn the mapping (management policy) from state space (S) to the set of actions (a)∈A resulting in reducing energy consumption and the computation burden on each one of the BSs.

Thus, for the use case where the least one operation parameter configured by performing the at least one action (a_{HP}) is setting (changing/updating) an hysteresis parameter, h*, the present disclosure refers to:
a computer-implemented method for (configuring at least one operation parameter:) setting a hysteresis parameter, h*, in a network cell served by a network node, the method comprising:
obtaining (at least one cell feature:) for example neighboring cell signal level, serving cell signal level, and/or the interference by the neighboring network cells from each one of a plurality of network cells, (the cell feature representing a cell state of respective network cell),
clustering a number of network cells into a number of cell clusters, wherein the clustering of network cells is performed based on (the obtained at least one cell feature:) for example neighboring cell signal level, serving cell signal level, and/or the interference by the neighboring network cells of respective network cell,
determining one network cell of respective cell cluster to be a representor cell of respective cell cluster,
and for at least one, preferably each, cell cluster:
determining (at least one action (a_{HP}):) setting (changing/updating) of the hysteresis parameter, h*, (to be performed for configuring at least one operation parameter) for a number of, preferably all, network cells of respective cell cluster, based on (the at least one cell feature:) for example neighboring cell signal level, serving cell signal level, and/or the interference by the neighboring network cells of the representor cell.

It is becoming increasingly popular to provide computing resources (both hardware and software) in nodes, remote servers or other entities where the resources are delivered as a service to remote users over a network. This means that functionality is distributed to one or more jointly acting virtual machines that can be positioned in separate physical nodes, thus what generally is referred to as in the cloud or in a cloud architecture. One aspect of using the capabilities offered by cloud architecture solutions currently discussed is what generally is referred to as C-RAN, Cloud- or Centralized-RAN, where many of the RAN components may be centralized and/or realized in the cloud. To give another example, New Radio use cases could require or benefit from distributing user and/or control plane functionality to different parts of a communication network.

Using cloud architecture solutions also opens up to using third party contractors to perform or take care of certain aspects of operations and/or computer resource demanding tasks. An example of a service that is suitable for such outsourcing is adding memory resources by having access to a distributed memory service. There is simultaneously a trend leading to consolidation of network functionality into virtualized software running on generic hardware in data centers.

It is appreciated that the skilled person will recognize that by taking advantage of the possibilities offered today, and probably even more so in the future, by what may be referred to as cloud architecture, cloud computing, edge cloud, edge computing, fog computing deployments and similar solutions, it is possible to allocate specific processing or method steps to a virtual machine implemented and executed at least in part in the cloud. Interrelated functions of a process may for example be performed by separate physical nodes, whereinafter the outcome of respective function or process subsequently may be made available and combined over the cloud. In some cases, it may not even be possible to specify or determine which actual node that performs respective function.

Thus, when herein referring to a method performed in a control node, such as for example a network node or a virtual machine, this is considered to also cover obvious embodiments where one or more method steps are completely or partially performed in the cloud, in the edge cloud or in a distributed manner, and subsequently made available to for the control node. For the purpose of the present disclosure, what herein generally is referred to as cloud architecture may for example be instantiated in a cloud, edge cloud or as a fog deployment.

According to examples of the present disclosure, the control node may be implemented in, or may be, a network node. If so, this network node may be considered to be a first network node, whereas the network node to which information enabling the network node to perform said at least one action (a) is transmitted may be considered to be a second network node.

The first, and/or second, network node may in turn be a Radio Access Network, RAN, node, for example of a NR communication network, a logical node implemented in a RAN node or implemented as a function in Centralized-RAN, C-RAN. According to other examples of the disclosure, the control node may be implemented as a virtual machine in a cloud computing architecture, in an edge cloud computing architecture or in a fog deployment. The control node may also be implemented as a function in an Operation Support System, OSS. Operation Support System, OSS, is a computer systems used by telecommunications service providers to manage the communication networks. The OSS supports management functions such as network inventory, service provisioning, network configuration and fault management. Together with Business Support System, BSS, it is used to support various end-to-end telecommunication services. BSS and OSS have their own data and service responsibilities. The control node may be also implemented as a function in an Open Radio Access Network, ORAN. The (second) network node may also be implemented as a function in an Open Radio Access Network, ORAN.

According to examples of the present disclosure, there is provided a control node of a communication network, the communication network connecting a plurality of network nodes, each network node serving at least one network cell, wherein the control node is configured to:
obtain at least one cell feature for each one of a plurality of network cells, the cell feature representing a cell state of respective network cell,
cluster a number of network cells into a number of cell clusters, wherein the clustering of network cells is performed based on the obtained at least one cell feature of respective network cell,
determine one network cell of respective cell cluster to be a representor cell of respective cell cluster,
   and, for examples of the disclosure where the determining action step is performed by the control node: for at least one cell cluster:
determine at least one action (a) to be performed for configuring at least one operation parameter for a number of network cells of respective cell cluster, based on the at least one cell feature of the representor cell.

According one example the control node comprises a communication interface, in turn comprising one or more transmitters and one or more receivers, a storage device, and processing circuitry associated with the communication interface and the storage device, wherein the storage device comprises machine, or computer, readable computer program instructions that, when executed by the processing circuitry, causes the control node to perform the above mentioned method steps.

Yet further examples of the disclosure relate to a control node, of a communication network, being configured to perform anyone of, or a combination of, the examples of methods defined herein and/or by the appended claims, that are defined as potentially being performed by a control node.

According to further examples of the present disclosure, there is provided a network node of a communication network, the communication network connecting a plurality of network nodes, each network node serving at least one network cell, wherein the network node the is configured to:
provide at least one cell feature for a network cells served by the network node, the cell feature representing a cell state of the network cell,
obtain information enabling at least one action (a), to be performed, and
cause the at least one action (a) to be performed.

For examples of the disclosure where the determining action step is performed by the network node, the network node may also be configured to:
determine at least one action (a) to be performed for configuring at least one operation parameter for a number of network cells of respective cell cluster, based on the at least one cell feature of the representor cell.

According to yet one example the network node comprises a communication interface, in turn comprising one or more transmitters and one or more receivers, a storage device, and processing circuitry associated with the communication interface and the storage device, wherein the storage device comprises machine, or computer, readable computer program instructions that, when executed by the processing circuitry, causes the network node to perform the above mentioned method steps.

Yet further examples of the disclosure relate to a network node, of a communication network, being configured to perform anyone of, or a combination of, the examples of methods disclosed herein and/or by the appended claims, that are defined as potentially being performed by the control node.

The present disclosure also refers to a computer program comprising instructions, or program code means, for performing the steps of anyone, or a combination of, examples of methods disclosed herein and/or by the appended claims, when said computer program is run on a computer or on processing circuitry of a network node and/or control node, a computer program product comprising such a computer program, and/or a computer readable medium on which such a computer program is stored.

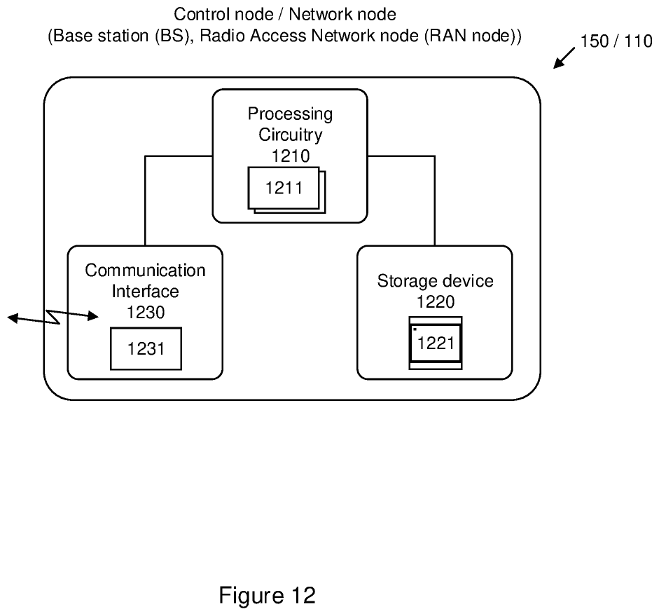

FIG. 12 schematically illustrates, in terms of a number of functional units, the general components of a network node 110 and/or a control node 150; processing circuitry 1210, processing unit(s) 1211, storage device 1220, computer program 1221, communication interface 1230, receiver(s)/transmitter(s)/transceiver(s) 1231 according to examples of the disclosure. Other components, as well as their functionality, of a network node 110 and/or a control node 150 are omitted in order not to obscure the concepts presented herein.

Since the following description is applicable for both examples of the disclosure of network nodes 110 and of some embodiments of control nodes 150, the network node 110 and/or the control node 150 is hereinafter simply referred to as “the device” 110/150.

The communication interface is 1230 coupled to the processing circuitry 1210 and the storage device 1220, wherein the memory of the storage device 1220 may comprises machine readable computer program instructions that, when executed by the processing circuitry 1210, for example may cause the device 110/150 to transmit and/or to receive a radio frequency waveform communication.

The processing circuitry 1210, comprises, and/or consists of, one or a number of interconnected processing unit(s) 1211, thus is provided using any combination of one or more of a suitable Central Processing Unit, CPU, multiprocessor, microcontroller, Digital Signal Processor, DSP, Graphical Processing Unit, GPU, Application Specific Integrated Circuit, ASIC, Field Programmable Gate Array, FPGA, or similar, capable of executing software instructions stored in/provided by a computer program product, for example in the form of a computer program 1221 stored in/on a storage device 1220. The processing circuitry 1210, and/or processing unit(s) 1211, controls the general operation of the device 110/150, for example by sending data and control signals to the interface 1230 and the storage device 1220, by receiving data and reports from the interface 1320, and by retrieving data and instructions from the storage device 1220.

The storage device 1220 may store a set of operations, and the processing circuitry 1210 may be configured to retrieve the set of operations from the storage device 1220 to cause the device 110/150 to perform the set of operations. The set of operations may be provided as a set of executable instructions. Thus, the processing circuitry 1210 is thereby arranged to execute methods as herein disclosed. Particularly, the processing circuitry 1210 is configured to cause the device 110/150 to perform a set of operations, or steps, of the methods discussed in connection to FIG. 3 to 5. 11a or 11b and discussed herein.

The storage device 1220 may comprise persistent storage, which, for example, can be any single one or combination of magnetic memory, optical memory, solid state memory or even remotely mounted memory.

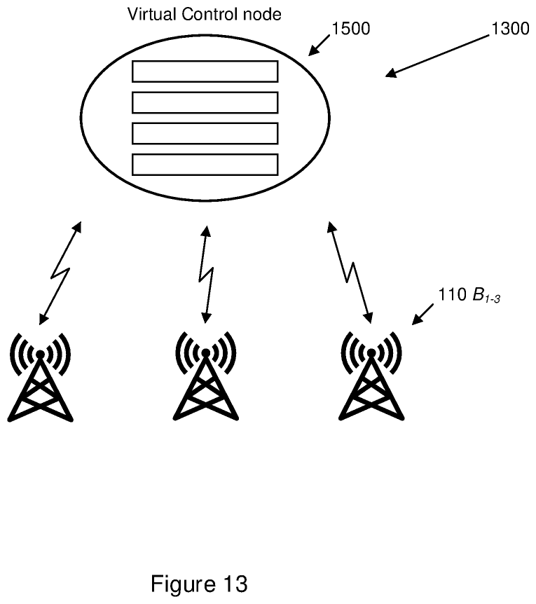

FIG. 13 schematically illustrates an example of the disclosure of a virtual realization of a control node 1500, such as for example a cloud computing architecture 1300, in which the virtual control node 1500 interacts with a number of network nodes 110 B₁₋₃. A virtual realization may be realized in a centralized manner or in distributed manner in which a number of virtual, interchangeable nodes are connected and operate together. The split between a physical node and one, or more, virtual nodes can be on different levels. Thus, also parts of herein proposed embodiments of methods may also be implemented on a remote server comprised in a cloud computing architecture 1300 or similar.

The following are certain enumerated embodiments further illustrating various aspects the disclosed subject matter.

1. A computer-implemented method for configuring at least one operation parameter in a network cell (140) served by a network node (110), of a communication network (100),
the method comprising:
   (S210) obtaining at least one cell feature for each one of a plurality of network cells (140), the cell feature representing a cell state of respective network cell (140),
   (S220) clustering a number of network cells (140) into a number of cell clusters (160), wherein the clustering of network cells (140) is performed based on the obtained at least one cell feature of respective network cell (140), and
   (S230) determining one network cell (140) of respective cell cluster (160) to be a representor cell (170),
and for at least one cell cluster (160):
   (S240) determining at least one action (a) to be performed for configuring at least one operation parameter for a number of network cells (140) of respective cell cluster (160), based on the at least one cell feature of the representor cell (170).

2. The method of embodiment 1, wherein the method further comprises:
(250) providing information to the network nodes (110) serving the network cells (140) from which at least one cell feature has been obtained and for which at least one action (a) to be performed has been determined, enabling respective network node (110) to perform said at least one action (a).

3. The method of embodiment 1 or 2, wherein the method step of (S240) determining at least one action (a) to be performed for configuring at least one operation parameter for a number of network cells (140) of respective cell cluster (160) is performed using a Reinforcement Learning, RL, agent.

4. The method of embodiment 3, wherein the Reinforcement Learning, RL, agent determines the action (a) to be performed based on a Reinforcement Learning, RL, agent policy it, wherein the Reinforcement Learning, RL, agent policy it provides a strategy for suggesting suitable actions (aₙ) given a current state (s) of the environment the Reinforcement Learning, RL, agent is acting in.

5. The method of embodiment 4, wherein for every action (a) performed in a network cell (140), a reward (r), indicating an observed impact of performing said action (a), given the current state (s) of the network cell (140), is calculated based on a performance metric of the network cell (140), the network node (110) and/or at least part of the communication network (100).

6. The method of any one of embodiment 1 to 5, wherein the method step of (S240) determining at least one action (a) to be performed for configuring at least one operation parameter for a number of network cells (140) is performed using a Reinforcement Learning, RL, agent, wherein the Reinforcement Learning, RL, agent is provided to determine at least one action (a) to be performed given a current state (s), wherein:
the state (s) is defined by the cell state of a representor cell (170),
the at least one action (a) to be performed corresponds to at least one action (a) to be performed in a number of network cells (140) for configuring at least one operation parameter in the network cell (140), and
a reward (r) is calculated per network cell (140) based on the outcome of performing said action (a).

7. The method of any one of embodiment 1 to 6, wherein the at least one action (a) determined is determined based on at least one cell feature characterizing a representor cell (170) at a time t, whereby the at least one action (a) is determined for time t and the reward (r) calculated is calculated for the at least one action (a) performed at time t.

8. The method of any one of embodiments 1 to 7, wherein the cell feature is at least one of:
number of measurements performed and/or reported by at least one wireless device (130) being provided service by the network node (110),
network cell signal level of at least one neighboring network cell (140), measured and reported by a network node (110) serving the at least one neighboring network cell (140),
network cell signal level of the network cell (140) of the network node (110),
interference caused by at least one neighboring network cell (140), measured by the network node (110),
number of handovers to/from the network cell (140) of the network node and/or a neighboring network cell (140),
information regarding mobility of a wireless device (130), and/or
information regarding available Radio Access Technologies, RATs, within the network cell (140).

9. The method of any one of embodiment 1 to 8, wherein the action (a) taken is at least one of:
changing an antenna transmitting direction (a_{RET}) of a Remote Electronic Tilt, RET, antenna a quantified or predetermined angle up, down, left or right,
setting an hysteresis parameter (a_{HP}) in an Radio Resource Control, RRC, configuration message,
determining Modulation and Coding Scheme, MCS, profile (a_{MCS}), and/or
configuring filter settings (a_{FS}).

10. The method of embodiment 5, wherein the performance metric is least one of:
throughput of a network node (110),
Quality of Service, QoS, experienced for operation over a network node (110),
number of measurements performed and/or reported by at least one wireless device (130) served by a network node (110),
net-power consumption of a communication network (100),
net-power consumption of a network node (110),
Signal-to-Interference-and-Noise Ratio, SINR, and/or
Radio Link Control, RLC, failure.

11. The method of any one of embodiments 1 to 10, wherein the method step of (S220) clustering a number of network cells (140) into a number of cell clusters (160), wherein the clustering of network cells (140) is performed based on the obtained at least one cell feature of respective network cell (140), comprises the method step of:
(S221) calculating a Joint Probability Density Function, JPDF, and
(S222) using the calculated Joint Probability Density Function, JPDF, to cluster the network cells (140).

12. The method of any one of embodiments 1 to 11, wherein the method step of (S230) determining one network cell (140) of respective cell cluster (160) to be a representor cell (170), is based on one of:
randomly selecting one network cell (140) of all the network cells (140) of the cell cluster (160),
selecting the network cell (140) being located closest to the geographical center of the cell cluster (160), or
randomly selecting one of a predetermined number of the network cells (140) being located closest to the geographical center of the cell cluster (160).

13. The method of any one of embodiment 1 to 12, wherein the method further comprises:
(S260) detecting conflicting outcomes of performing said at least one action (a) in network cells (140) of a cell cluster (160) by evaluating the rewards (rₙ) calculated for respective network cell (140).

14. The method of embodiment 13, wherein the method further comprises:
(S260) detecting conflicting outcomes of performing said at least one action (a) in network cells (140) nₖ of a cell cluster (160) by evaluating the rewards (rₙ) calculated for respective network cell (140),
   and wherein for all network cells (140) nₖ of a cell cluster (160) a positive reward (r) is assigned a value of y=1 and a negative reward (r) is assigned a value of y=0, and wherein all assigned values are summed up as yₖ, and wherein if yₖ<nₖ a conflicting outcome in a cell cluster (160) is detected.

15. The method of embodiment 14, wherein the method further comprises:
(S270) incorporating that conflicting outcome of performing said at least one action (a) in network cells (140) of a cell cluster (160) at time tis detected into the state (s) of the representor cell (170), when repeating the method at time t+1.

16. The method of any one of embodiments 13 to 15, wherein the method further comprises:
(S280) obtaining at least one cell feature, comprising at least one cell feature characterizing respective network cell at a time t+1, for a plurality of network cells (160, and
(S290) determining at least one action (aₜ₊₁) to be performed at a time t+1 for configuring at least one operation parameter for a number of network cells (140) of respective cell cluster (160).

17. The method of embodiment 16, wherein the method step of:
(S290) determining at least one action (aₜ₊₁) to be performed at a time t+1 for configuring at least one operation parameter for number of network cells (140) of respective cell cluster (160),
   is performed by:
(S300) selecting the action (aₜ₊₁) for which the cumulative reward (r_{tot,t}) of the cell cluster (160) is as high as possible, or the number of positive rewards (rₜ) is as close to the maximum number of positive rewards (rₙ) as possible.

18. The method of any one of embodiments 13 to 17, wherein if the total number of conflicting outcomes detected in a plurality of cell clusters (160) exceeds a threshold value v, re-clustering is triggered.

19. The method of any one of embodiments 1 to 18, wherein the method further comprises the method step of:
(S310) re-clustering the network cells (140), wherein the clustering of network cells (140) is performed based on obtained at least one cell feature of respective network cell (160) at time t+1.

20. The method of any one of embodiment 3 to 19, wherein the Reinforcement Learning, RL, agent is a Local Reinforcement Learning, RL, agent (700), wherein each cell cluster (160) is provided with one Local RL agent (700).

21. The method of embodiment 20, wherein respective Reinforcement Learning, RL, agent is implemented in a network node (110).

22. The method of embodiment 21, wherein the method step of:
(S240) determining at least one action (a) to be performed for configuring the at least one operation para meter for a number of network cells (140) of respective cell cluster (160), based on the at least one cell feature of the representor cell (170),
   is performed at the network node (110).

23. The method of any one of embodiments 3 to 19, wherein the Reinforcement Learning, RL, agent is a Master Reinforcement Learning, RL, agent (800) configured to determine at least one action (a) to be performed for configuring at least one operation parameter for a number cell cluster (160), and wherein respective at least one action (a) is provided by the Master Reinforcement Learning, RL, agent to respective network cluster (170), as a vector of v (actions (aₙ)).

24. The method of embodiment 23, wherein the communication network (100) further comprising a control node (150), and wherein the Reinforcement Learning, RL, agent is implemented in the control node (150).

25. The method of embodiment 24, wherein the method step of:
(S240) determining at least one action (a) to be performed for configuring the at least one operation para meter for a number of network cells (140) of respective cell cluster (160), based on the at least one cell feature of the representor cell (170).
   is performed at the control node (150).

26. The method of any one of the preceding embodiments, wherein the network node (110) is a Radio Access Network, RAN, node, or a logical node implemented in a RAN node.

27. The method of any one of the preceding embodiments, wherein the control node (150) is implemented as a virtual machine in a cloud computing architecture (1300), in an edge cloud computing architecture, a fog deployment or as a function in Centralized-RAN, C-RAN.

28. The method of any one of the preceding embodiments, wherein the control node (150) is implemented as a function in an Operation Support System, OSS.

29. The method of any one of the preceding embodiments, wherein the control node (150) is implemented as a function in an Open Radio Access Network, ORAN.

30. A computer-implemented method, performed in a control node (150), for configuring at least one operation parameter in a network cell (140) served by a network node (110), of a communication network (100),
the method comprising:
   (S210) obtaining at least one cell feature for each one of a plurality of network cells (140), the cell feature representing a cell state of respective network cell (140),
   (S220) clustering a number of network cells (140) into a number of cell clusters (160), wherein the clustering of network cells (140) is performed based on the obtained at least one cell feature of respective network cell (140), and
   (S230) determining one network cell (140) of respective cell cluster (160) to be a representor cell (170).

31. The method of embodiment 30, further comprising the method steps of any one of embodiments 8, 11, 19 or 26 to 29.

32. The method of embodiment 30, further comprising:
for at least one cell cluster (160):
   (S240) determining at least one action (a) to be performed for configuring at least one operation parameter for a number of network cells (140) of respective cell cluster (160), based on the at least one cell feature of the representor cell (170).

33. The method of embodiment 32, further comprising the method steps of any one of embodiments 2 to 12, 16, 17, 19 or 23 to 29.

34. A computer-implemented method, performed in a network node (110) of a communication network (100), for configuring at least one operation parameter in a network cell (140) served by the network node (110), the method comprising:
(S1110) providing at least one cell feature for a network cell (140) served by the network node (110), the cell feature representing a cell state of the network cell (140),
(S1120) obtaining information enabling at least one action (a) to be performed, and
(S1130) causing the at least one action (a) to be performed.

35. The method of embodiment 34, wherein the method step of (S1110) providing at least one cell feature for a network cells (140) served by the network node (110), the cell feature for representing a cell state of the network cell (140), comprises:—(S1111) transmitting the at least one cell feature for the network cell (140) served by the network node (110) to a control node (150).

36. The method of any one of embodiments 34 or 35, wherein the method step of (S1120) obtaining information enabling at least one action (a) to be performed, comprises:
(S1121) receiving information enabling the at least one action (a) determined to be performed.

37. The method of any one of embodiments 34 to 36, further comprising the method steps of any one of embodiments 8, 13 to 15, 18 or 26 to 29.

38. A computer-implemented method, performed in a network node (110) of a communication network (100), for configuring at least one operation parameter in a network cell (140) served by the network node (110), the method comprising:
(S1110) providing at least one cell feature for the network cell (140) served by the network node (110), the cell feature representing a cell state of the network cell (140),
(S1140) obtaining information indicating that the network node (110) is serving a representor cell (170),
(S240) determining at least one action (a) to be performed for configuring the at least one operation parameter for a number of network cells (140) of the cell cluster (160) to which the representor cell (170) belongs, based on the at least one cell feature of the representor cell (170), and
(S1130) causing the at least one action (a) to be performed.

39. The method of embodiment 38, wherein the method further comprises:
(250) providing information to a number of network nodes (110) serving the network cells (140) of the cell cluster (160) to which the representor cell (170) belongs, and for which at least one action (a) to be performed has been determined, enabling respective network node (110) to perform said at least one action (a).

40. The method of embodiment 38 or 39, further comprising the method steps of any one of embodiments 3 to 10, 13 to 18, 20 to 22 or 26 to 29.

41. A control node (150) in a communication network (100), the communication network (100) connecting a plurality of network nodes (110), each network node (110) serving at least one network cell (140), wherein the control node (150) is configured to:
obtain at least one cell feature for each one of a plurality of network cells (140), the cell feature representing a cell state of respective network cell (140),
cluster a number of network cells (140) into a number of cell clusters (160), wherein the clustering of network cells (140) is performed based on the obtained at least one cell feature of respective network cell (140), and
determine one network cell (140) of respective cell cluster (160) to be a representor cell (170).

42. The control node (150) of embodiment 41, further being configured to perform the method steps of any one of embodiments 8, 11, 19 or 26 to 29.

43. The control node (150) of embodiment 41, further being configured to for at least one cell cluster (160):
determine at least one action (a) to be performed for configuring at least one operation parameter for a number of network cells (140) of respective cell cluster (160), based on the at least one cell feature of the representor cell (170).

44. The control node (150) of embodiment 43, further being configured to perform the method steps of any one of embodiments 2 to 12, 16, 17, 19 or 22 to 29.

45. A network node (110) of a communication network (100), the communication network (100) connecting a plurality of network nodes (110), each network node (110) serving at least one network cell (140), wherein the network node (110) is configured to:
provide at least one cell feature for a network cell (140) served by the network node (110), the cell feature representing a cell state of the network cell (140),
obtain information enabling at least one action (a), to be performed, and
cause the at least one action (a) to be performed.

46. The network node (110) of embodiment 45, further being configured to perform the method steps of any one of embodiments 8, 13 to 15, 18 or 26 to 29.

47. A network node (110) of a communication network (100), the communication network (100) connecting a plurality of network nodes (110), each network node (110) serving at least one network cell (140), wherein the network node (110) is configured to:
provide at least one cell feature for the network cell (140) served by the network node (110), the cell feature representing a cell state of the network cell (140),
obtain information indicating that the network node (110) is serving a representor cell (170),
determine at least one action (a) to be performed for configuring the at least one operation parameter for a number of network cells (140) of the cell cluster (160) to which the representor cell (170) belongs, based on the at least one cell feature of the representor cell (170), and
cause the at least one action (a) to be performed.

48. The network node (110) of embodiment 47, further being configured to perform the method steps of any one of embodiments 2 to 10, 13 to 17, 20 to 22 or 26 to 29.

49. A computer program (1221) comprising instructions for performing the steps of any of embodiments 1 to 40 when said computer program is run on a computer device, or on a processing circuitry (1210) of a control node (150) and/or a network node (110),
a computer program product comprising such a computer program (1221), and/or
a computer readable medium on which such a computer program (1221) is stored.

50. A system comprising a control node (150) and a plurality of network nodes (110), each network node (110) serving at least one network cell (140), of a communication network (100), the system being configured to:
obtain at least one cell feature for a plurality of network cells (140), wherein the at least one cell feature is provided by the network node (110) of respective network cell (140), respective cell feature representing a cell state of respective network cell (140),
cluster a number of network cells (140) into a number of cell clusters (160), wherein the clustering of network cells (140) is performed based on the obtained at least one cell feature of respective network cell (140),
determine one network cell (140) of respective cell cluster (160) to be a representor cell (170),
   and for at least one cell cluster (160):
determine, at least one action (a) to be performed for configuring at least one operation parameter for a number of network cells (140) of respective cell cluster (160), based on the at least one cell feature of the representor cell (170),
provide information enabling the at least one action (a), to be performed, to respective network node (110),
   whereby respective network node (110) may:
cause the at least one action (a) to be performed.

51. A system of embodiment 50, further being configured to perform any one of the method steps of embodiments 2 to 29.

1-49. (canceled)

50. A method for configuring at least one operation parameter in a network cell served by a network node, of a communication network, the method comprising:
obtaining at least one cell feature for each one of a plurality of network cells, the cell feature representing a cell state of respective network cell;
clustering a number of network cells into a number of cell clusters, wherein the clustering of network cells is performed based on the obtained at least one cell feature of respective network cell; and
determining one network cell of respective cell cluster to be a representor cell, and for at least one cell cluster:
determining at least one action to be performed for configuring at least one operation parameter for a number of network cells of respective cell cluster, based on the at least one cell feature of the representor cell.

51. The method of claim 50, wherein the method further comprises:
providing information to the network nodes serving the network cells from which at least one cell feature has been obtained and for which at least one action to be performed has been determined, enabling respective network node to perform said at least one action.

52. The method of claim 50, wherein the method step of determining at least one action to be performed for configuring at least one operation parameter for a number of network cells of respective cell cluster is performed using a Reinforcement Learning, RL, agent.

53. The method of claim 50, wherein the method step of determining at least one action to be performed for configuring at least one operation parameter for a number of network cells is performed using a Reinforcement Learning, RL, agent, wherein the Reinforcement Learning, RL, agent is provided to determine at least one action to be performed given a current state, wherein:
the current state is defined by the cell state of a representor cell;
the at least one action to be performed corresponds to at least one action to be performed in a number of network cells for configuring at least one operation parameter in the network cell; and
a reward is calculated per network cell based on the outcome of performing said action.

54. The method of claim 50, wherein the cell feature is at least one of:
a number of measurements performed and/or reported by at least one wireless device being provided service by the network node;
a network cell signal level of at least one neighboring network cell, measured and reported by a network node serving the at least one neighboring network cell;
a network cell signal level of the network cell of the network node;
an interference caused by at least one neighboring network cell, measured by the network node;
a number of handovers to/from the network cell of the network node and/or a neighboring network cell;
an information regarding mobility of a wireless device; and/or
an information regarding available Radio Access Technologies, RATs, within the network cell.

55. The method of claim 50, wherein the action taken is at least one of:
changing an antenna transmitting direction (a_{RET}) of a Remote Electronic Tilt, RET, antenna a quantified or predetermined angle up, down, left or right;
setting an hysteresis parameter (a_{HP}) in an Radio Resource Control, RRC, configuration message;
determining Modulation and Coding Scheme, MCS, profile (a_{MCS}); and/or
configuring filter settings (a_{FS}).

56. The method of claim 50, wherein the method step of clustering a number of network cells into a number of cell clusters, wherein the clustering of network cells is performed based on the obtained at least one cell feature of respective network cell, comprises the method step of:
calculating a Joint Probability Density Function, JPDF; and
using the calculated Joint Probability Density Function, JPDF, to cluster the network cells.

57. The method of claim 50, wherein the method step of determining one network cell of respective cell cluster to be a representor cell, is based on one of:
randomly selecting one network cell of all the network cells of the cell cluster;
selecting the network cell being located closest to the geographical center of the cell cluster; or
randomly selecting one of a predetermined number of the network cells being located closest to the geographical center of the cell cluster.

58. The method of claim 50, wherein the method further comprises:
detecting conflicting outcomes of performing said at least one action in network cells of a cell cluster by evaluating the rewards (rₙ) calculated for respective network cell.

59. The method of claim 50, wherein the method further comprises the method step of:
re-clustering the network cells, wherein the clustering of network cells is performed based on obtained at least one cell feature of respective network cell at time t+1.

60. The method of claim 50, wherein the network node is a Radio Access Network, RAN, node, or a logical node implemented in a RAN node.

61. The method of claim 50, wherein the control node is implemented as a virtual machine in a cloud computing architecture, in an edge cloud computing architecture, a fog deployment or as a function in Centralized-RAN, C-RAN.

62. The method of claim 50, wherein the control node is implemented as a function in an Operation Support System, OSS.

63. The method of claim 50, wherein the control node is implemented as a function in an Open Radio Access Network, ORAN.

64. A control node operable in a communication network, the communication network connecting a plurality of network nodes, each network node serving at least one network cell, the control node comprising:
a hardware processor and a memory, the memory containing instructions executable by the hardware processor whereby the control node is configured to:
obtain at least one cell feature for each one of a plurality of network cells, the cell feature representing a cell state of respective network cell;
cluster a number of network cells into a number of cell clusters, wherein the clustering of network cells is performed based on the obtained at least one cell feature of respective network cell; and
determine one network cell of respective cell cluster to be a representor cell.

65. The control node of claim 64, wherein the cell feature is at least one of:
a number of measurements performed and/or reported by at least one wireless device being provided service by the network node;
a network cell signal level of at least one neighboring network cell, measured and reported by a network node serving the at least one neighboring network cell;
network cell signal level of the network cell of the network node;
an interference caused by at least one neighboring network cell, measured by the network node;
a number of handovers to/from the network cell of the network node and/or a neighboring network cell;
a information regarding mobility of a wireless device; and/or
a information regarding available Radio Access Technologies, RATs, within the network cell.

66. The control node of claim 64, further being configured to for at least one cell cluster:
determine at least one action to be performed for configuring at least one operation parameter for a number of network cells of respective cell cluster, based on the at least one cell feature of the representor cell.

67. The control node of 66, wherein the control node is further configured to:
provide information to the network nodes serving the network cells from which at least one cell feature has been obtained and for which at least one action to be performed has been determined, enabling respective network node to perform said at least one action.

68. A system comprising a control node and a plurality of network nodes, each network node configured to serve at least one network cell of a communication network, the system being configured to:
obtain at least one cell feature for a plurality of network cells, wherein the at least one cell feature is provided by the network node of respective network cell, respective cell feature representing a cell state of respective network cell;
cluster a number of network cells into a number of cell clusters, wherein the clustering of network cells is performed based on the obtained at least one cell feature of respective network cell;
determine one network cell of respective cell cluster to be a representor cell,
and for at least one cell cluster:
determine, at least one action to be performed for configuring at least one operation parameter for a number of network cells of respective cell cluster, based on the at least one cell feature of the representor cell;
provide information enabling the at least one action, to be performed, to respective network node; and
whereby respective network node may:
cause the at least one action to be performed.

69. The system of claim 68, wherein the system is further configured to:
provide information to the network nodes serving the network cells from which at least one cell feature has been obtained and for which at least one action to be performed has been determined, enabling respective network node to perform said at least one action.
